(19) United States
(12) Patent Application Publication
(10) Pub. No.: US 2026/0261646 A1
(43) Pub. Date: Sep. 3, 2026

(54) REMOTE VISUAL RECOGNITION SYSTEM, SITE IMAGING SYSTEM

(71) Applicant: SONY GROUP CORPORATION, TOKYO (JP)

(72) Inventors: SHOGO KUBOTA, TOKYO (JP); MARIKO NISHIYAMA, TOKYO (JP); ATSUHIRO CHIBA, TOKYO (JP); TETSUO IKEDA, TOKYO (JP); HIROAKI TORIUMI, TOKYO (JP); YUYA TAKAYAMA, TOKYO (JP); MAHO HAYASHI, TOKYO (JP)

(21) Appl. No.: 18/876,082

(22) PCT Filed: Jun. 9, 2023
(86) PCT No.: PCT/JP2023/021515

§ 371 Date: Dec. 17, 2024

(30) Foreign Application Priority Data
Jun. 22, 2022 (JP) 2022-100377

(51) Int. Cl. H04N 13/383; H04N 13/296; H04N 13/398

(52) U.S. Cl. CPC H04N 13/383; H04N 13/296; H04N 13/398

(57) ABSTRACT

A remote visual recognition system includes: a display device that displays an image at a wider angle than a visual field range of a person; a head position/direction detection device that detects a position and a direction of a head of a viewer of the display device; and a control device that performs processing of causing the display device to display a captured image at a remote location received from a site imaging system, and processing of generating gaze direction information on the basis of information on the position and the direction of the head of the viewer by the head position/direction detection device, and transmitting the gaze direction information to the site imaging system. A site imaging system includes: an imaging device that captures an image at a wider angle than a visual field range of a person; a direction indication device that indicates a direction; and a control device that performs processing of transmitting a captured image of the imaging device to a remote visual recognition system and processing of controlling an indication direction by the direction indication device on the basis of received gaze direction information.

### TECHNICAL FIELD

The present technology relates to a remote visual recognition system and a site imaging system that communicate with each other.

### BACKGROUND ART

With development of communications technologies, a use case of remote travel has been proposed. A user views a video and a sound transmitted in real time of a state on a site side at a travel destination while communicating with a participant on the site side without going to the travel destination. As a result, it is possible to enjoy an experience as if the user himself/herself went on a trip.

On the other hand, there is a technique that can be classified as an all-around display. This refers to a display arranged such that a single or a plurality of users can be surrounded by a single screen including a curved surface or a plurality of flat surfaces. Specifically, it is configured by projection by a plurality of projectors or a modular display such as a light emitting diode (LED) board.

Patent Document 1 below discloses a technique related to an all-around display.

Patent Document 2 discloses an invention relating to display of an image captured and distributed by an imaging device, particularly exposure control.

### CITATION LIST

### Patent Document

Patent Document 1: Japanese Patent Application Laid-Open No. 2020-155847

Patent Document 2: Japanese Patent Application Laid-Open No. 2006-319474

### SUMMARY OF THE INVENTION

### Problems to be Solved by the Invention

The all-around display provides a user with a realistic and immersive video experience, and thus is suitable for the purpose of the remote travel described above.

In order for the participant on the site side and the user on the all-around display side to feel the sense of having traveled together in this remote travel or the like, a state in which “the same thing looks the same” on the site side is ideal for both of them.

However, a state in which “the same thing looks the same” cannot be realized simply by distributing a captured image of a site such as a travel destination and causing the user in the remote location to view the captured image.

Therefore, an object of the present technology is to enable an image (scene) to be appropriately shared between a site user and a user visually recognizing a display at a remote location, for example, in remote travel or the like.

### Solutions to Problems

A remote visual recognition system according to the present technology includes: a display device that displays an image at a wider angle than a visual field range of a person; a head position/direction detection device that detects a position and a direction of a head of a viewer of the display device; and a control device that performs processing of causing the display device to display a captured image at a remote location transmitted from a site imaging system, and processing of generating gaze direction information on the basis of information on the position and the direction of the head of the viewer by the head position/direction detection device, and transmitting the gaze direction information to the site imaging system.

In the remote visual recognition system, the display device enables visual recognition of a scene imaged by a site imaging system at a remote location. In this case, the gaze direction of the viewer is transmitted to the site imaging system.

A site imaging system according to the present technology includes: an imaging device that captures an image at a wider angle than a visual field range of a person; a direction indication device that indicates a direction; and a control device that performs processing of transmitting a captured image of the imaging device to a remote visual recognition system and processing of controlling an indication direction by the direction indication device on the basis of gaze direction information of a viewer of a display device in the remote visual recognition system.

On the site imaging system side, a direction in which the viewer of the remote visual recognition system gazes at the real scene is indicated.

Furthermore, a site imaging system according to the present technology includes: an imaging device that captures an image at a wider angle than a visual field range of a person; and a control device that performs processing of transmitting a captured image of the imaging device to a remote visual recognition system, and controls the imaging device on the basis of gaze direction information of a viewer of a display device in the remote visual recognition system.

On the site imaging system side, the imaging device is controlled according to the direction visually recognized by the viewer of the remote visual recognition system.

### BRIEF DESCRIPTION OF DRAWINGS

FIG. 1 is a block diagram of a system configuration of a first embodiment of the present technology.

FIG. 2 is an explanatory diagram of an omnidirectional display device used in the embodiment.

FIG. 3 is an explanatory diagram of an aspect of a site-side system of the embodiment.

FIG. 4 is an explanatory diagram of an aspect of a direction indication device of the embodiment.

FIG. 5 is an explanatory diagram of an aspect of a direction indication device of the embodiment.

FIG. 6 is an explanatory diagram of an aspect of a direction indication device of the embodiment.

FIG. 7 is an explanatory diagram of an aspect of a site-side system of the embodiment.

FIG. 8 is an explanatory diagram of an aspect of a site-side system of the embodiment.

FIG. 9 is an explanatory diagram of an aspect of a site-side system of the embodiment.

FIG. 10 is an explanatory diagram of an aspect of a site-side system of the embodiment.

FIG. 11 is a block diagram of an information processing apparatus of the embodiment.

FIG. 12 is an explanatory diagram of a sequence of communication and processing between systems of the embodiment.

FIG. 13 is an explanatory diagram of generation of gaze direction information of the embodiment.

FIG. 14 is a flowchart of processing of a remote visual recognition system of the first embodiment.

FIG. 15 is a flowchart of processing of a site imaging system of the first embodiment.

FIG. 16 is a block diagram illustrating a system configuration of a second embodiment.

FIG. 17 is a flowchart of processing of a remote visual recognition system of the second embodiment.

FIG. 18 is a block diagram of a system configuration of a third embodiment.

FIG. 19 is an explanatory diagram of a display image of an omnidirectional display of a third embodiment.

FIG. 20 is an explanatory diagram of a display image of a sub display of a third embodiment.

FIG. 21 is a flowchart of processing of a remote visual recognition system of the third embodiment.

FIG. 22 is an explanatory diagram of a display image of a sub display of the third embodiment.

FIG. 23 is a flowchart of processing of a remote visual recognition system of a fourth embodiment.

FIG. 24 is a flowchart of processing of a site imaging system of the fourth embodiment.

FIG. 25 is an explanatory diagram of a display image of an omnidirectional display of a fifth embodiment.

FIG. 26 is an explanatory diagram of a display image of an omnidirectional display of the fifth embodiment.

FIG. 27 is an explanatory diagram of generation of gaze direction information of the fifth embodiment.

FIG. 28 is an explanatory diagram of a compression rate for each region of a sixth embodiment.

FIG. 29 is a flowchart of processing of a site imaging system of the sixth embodiment.

### MODE FOR CARRYING OUT THE INVENTION

Hereinafter, embodiments will be described in the following order.
<1. First Embodiment>
<2. Second Embodiment>
<3. Third Embodiment>
<4. Fourth Embodiment>
<5. Fifth Embodiment>
<6. Sixth Embodiment>
<7. Plurality of Remote Users 5>
<8. Summary and Modification>

Note that, in the present disclosure, “images” include both moving images and still images. Although a moving image will be mainly described as an example, the captured or displayed image is not limited to a moving image, and may be a still image or a slide show using a plurality of still images. In particular, “image” and “video” are not distinguished from each other, and are mainly referred to as “image” in the following description.

In addition, the “image” refers to an image actually displayed on a screen, but the “image” in a signal processing process or a transmission path until being displayed on the screen refer to image data.

### 1. First Embodiment

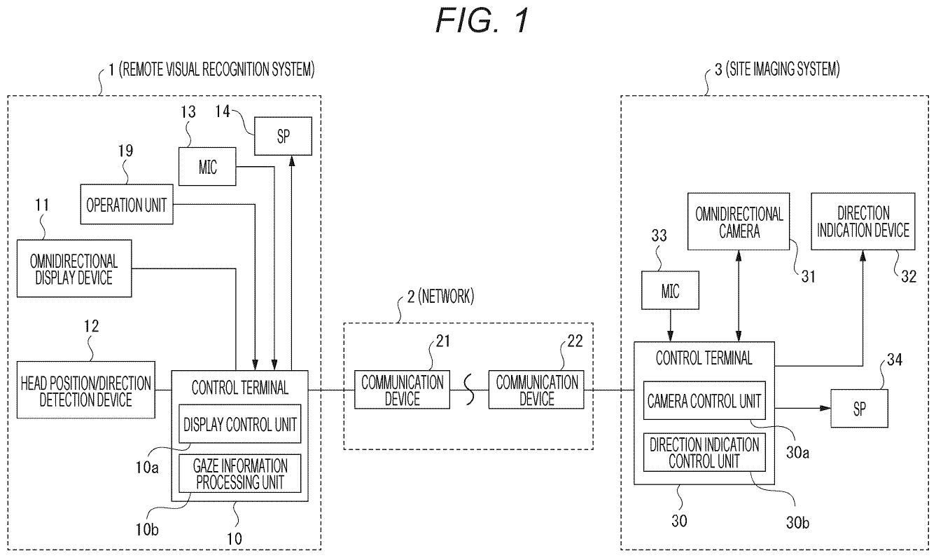

FIG. 1 illustrates a system configuration of a first embodiment.

The system of the embodiment is configured such that a remote visual recognition system 1 and a site imaging system 3 can communicate with each other via a network 2.

That is, the remote visual recognition system 1 and the site imaging system 3 side can communicate with each other by network communication between a communication device 21 on the remote visual recognition system 1 side and a communication device 22 on the site imaging system 3 side.

As the network 2, for example, the Internet, a home network, a local area network (LAN), a satellite communication network, a telephone communication network, and other various networks are assumed. Note that the remote visual recognition system 1 and the site imaging system 3 may be directly communicably connected without the network 2.

The remote visual recognition system 1 includes at least a control terminal 10, an omnidirectional display device 11, and a head position/direction detection device 12. In addition, devices for a user interface, such as a microphone 13, a speaker 14, and an operation unit 19, may be provided as illustrated.

The site imaging system 3 includes at least a control terminal 30, an omnidirectional camera 31, and a direction indication device 32. In addition, a device for a user interface, such as a microphone 33, a speaker 34, or the like, may be provided as illustrated.

The remote visual recognition system 1 and the site imaging system 3 provide a user with an experience such as remote travel.

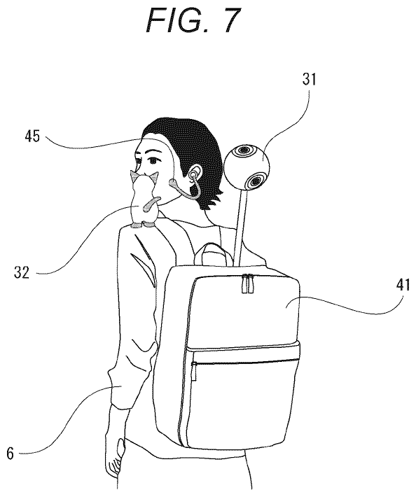

The site imaging system 3 is assumed to be possessed by a user (hereinafter referred to as “site user 6” (see FIG. 7 and the like) ) who is at a site such as a travel destination, or is assumed to move together with the site user 6.

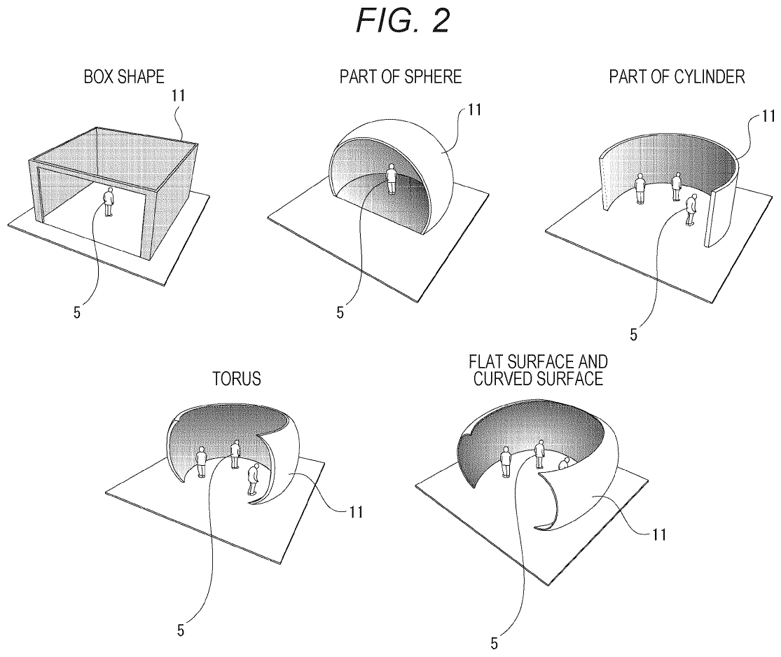

The remote visual recognition system 1 is a facility in a place away from the site and is constructed in a place where the omnidirectional display device 11 is arranged, and a user in the remote location (hereinafter referred to as a “remote user 5” (see FIG. 2) ) can visually recognize a scene on the site by an image distributed.

For example, in the site imaging system 3, a surrounding scene is imaged by the omnidirectional camera 31. The captured image is transmitted to the remote visual recognition system 1 via the network 2.

In the remote visual recognition system 1, the omnidirectional display device 11 displays a scene on the site. As a result, the remote user 5 who visually recognizes the omnidirectional display device 11 can visually recognize a scene equivalent to the scene actually viewed by the site user 6.

In particular, the omnidirectional display device 11 is configured as a display device that is called an all-around display or the like and displays an image having a wider angle than a visual field range of a person.

However, in the present disclosure, the term “full celestial sphere” or “full circumference” is not necessarily used in a strict sense. That is, it does not necessarily mean a periphery of 360 degrees or the entire periphery as a three-dimensional space, and it is assumed that an image can be displayed in a range wider than a general human visual field range.

For example, FIG. 2 illustrates an example of the omnidirectional display device 11.
Box shape/prism shape
spherical (dome or part of dome)
Cylindrical (part of cylinder)
Torus
Combination of flat surface and curved surface and the like are assumed.

Desirably, as illustrated in the drawing, a large display that widely surrounds the periphery of one or a plurality of remote users 5 is assumed so that the remote users 5 can freely move in an internal area surrounded by the display. In addition, a chair, a sofa, or the like may be provided in the internal area, and the remote user 5 may sit on the chair or the like and visually recognize the surroundings.

By displaying the scene viewed by the site user 6 on the omnidirectional display device 11, the remote user 5 shares the scene of the travel destination of the site user 6. In particular, since the omnidirectional display device 11 is a large display that widely surrounds the periphery of the remote user 5, the remote user 5 can easily obtain a sense of immersion. This is because the omnidirectional display device 11 displays a wider range than a human visual field, so that the remote user 5 can experience a state close to a state of actually being at the site by looking around at an arbitrary position in the internal area.

Such an omnidirectional display device 11 can realize the above-described shape by, for example, the following configuration example.
Modular display such as an LED wall
Projector
FPD (Flat Panel Display) or curved display

The modular display such as an LED wall is a large display having various shapes as illustrated in FIG. 2, for example, by arranging a plurality of LED display panels in the horizontal and vertical directions.

Regarding the projector, it is conceivable to perform whole circumference projection by one projector via a fisheye lens or the like. Alternatively, a plurality of projectors may be used, and projection may be performed by edge blending such that the vicinity of the boundary of the angle of view range of each projector becomes a smooth image.

The FPD and the curved display may be used alone, or a plurality of FPDs and curved displays may be tiled and used.

Note that the omnidirectional display device 11 may be able to display a stereo image.

Furthermore, the omnidirectional display device 11 may include a sound output unit and output a site sound.

For example, a sound collected by the microphone 33 in the site imaging system 3 in FIG. 1 is transmitted to the remote visual recognition system 1. In the remote visual recognition system 1, the speaker 14 outputs the sound transmitted from the site imaging system 3 to the internal area of the omnidirectional display device 11.

As a result, the remote user 5 can not only see the scene on the site but also listen to the site environmental sound, the voice of the site user 6, and the like.

Furthermore, it is preferable that the microphone 13 that collects a voice or the like uttered by the remote user 5 in the omnidirectional display device 11 is provided and the voice or the like is transmitted to the site imaging system 3. The site imaging system 3 side receives a sound such as the voice of the remote user 5 and outputs the sound from the speaker 34. As a result, the site user 6 can listen to the voice and the like of the remote user 5.

By conveying sounds to each other in this manner, the remote user 5 can have an experience of actually being at a travel destination together with the site user 6.

For display on the omnidirectional display device 11 as described above, the site imaging system 3 is provided with the omnidirectional camera 31.

The omnidirectional camera 31 is selected from, for example, the following.
A single camera with a fisheye lens with an angle of view of 180 to 250 degrees
Two cameras with fisheye lenses are arranged back-to-back to enable 360 degree imaging.
One in which a plurality of cameras is arranged on a substantially circumferential surface or a substantially spherical surface to enable imaging from 180 degrees to 360 degrees.

In a case where two or more cameras are used, the site imaging system 3 side or the remote visual recognition system 1 side performs stitching processing on a captured image so that a seamless entire surrounding image can be displayed.

Furthermore, the omnidirectional camera 31 may further perform stereo imaging with adjacent cameras. As a result, a three-dimensional video is displayed on the omnidirectional display device 11, and the remote user 5 can obtain a stronger sense of immersion.

In the present embodiment, by providing the head position/direction detection device 12 in the remote visual recognition system 1, it is possible to detect the gaze direction of the remote user 5 and notify the site imaging system 3 of the detected gaze direction as gaze direction information.

Correspondingly, the site imaging system 3 is provided with the direction indication device 32 so that the direction in which the remote user 5 is gazing can be presented to the site user 6.

This is for the following reason.

At present, it is generally assumed that image sharing between remote locations is viewed on a small flat display such as a personal computer or a television monitor. In this case, the user can designate a region on the display screen by an operation with a pointing device or a touch. For example, in a case where a part of the omnidirectional image is cut out and displayed, such an operation can be performed, and a user can view an image in an arbitrary direction in the omnidirectional image.

However, in a case where a large display such as the above-described omnidirectional display device 11 is used in a use case such as remote travel, it is not easy for a remote user 5 to notify a site user 6 of his/her gaze region.

This is because when the display region is wide and the user has a large expected angle with respect to the display as in the omnidirectional display device 11, it is not possible to look around at one time, and the representative point of the display region (for example, the center of the display region) and the gaze region do not necessarily coincide with each other.

In addition, since the display region is wide, an operation by a pointing device or a touch also needs to be performed within a wide range, which is not an easy operation.

In order to input the gaze region of the remote user 5 with respect to the omnidirectional display device 11 to the system as in the present embodiment, it is considered effective to sense the line-of-sight direction of the remote user 5. However, the positional relationship between the omnidirectional display device 11 and the user (including the orientation of the user) is not fixed unlike the case of the flat display. In the case of the flat display, it is assumed that the user faces the center of the screen, but in the case of the present embodiment, the remote user 5 can move in the internal area of the omnidirectional display device 11 as described above. Therefore, it is necessary for the remote user 5 to measure not only the line-of-sight direction but also the position of the head.

Therefore, the remote visual recognition system 1 is provided with the head position/direction detection device 12, and detects the position and direction of the head of the remote user 5 visually recognizing the omnidirectional display device 11.

The position of the head is a position in the internal area of the omnidirectional display device 11, and may be considered as a position where the remote user 5 is present.

The head direction is the orientation of the face (eyes) and corresponds to the line-of-sight direction.

The head position/direction detection device 12 detects the position/direction of the head of the remote user 5 and notifies the control terminal 10 of the position/direction. As a result, the control terminal 10 can determine which direction in the omnidirectional display device 11 the remote user 5 is visually recognizing. Details of the determination processing will be described later.

The head position/direction detection device 12 can be implemented as, for example, a tracker worn on the head by the remote user 5, an imaging/image analysis system that images the remote user 5 and performs posture estimation, or the like.

Examples of the tracker include an outside-in tracker. This is composed of a combination of a synchronized light source and detector (tracker side).

The light source sweeps the sheet-shaped beam in the X and Y directions of the inner area of the omnidirectional display device 11, and the detector detects the sheet-shaped beam to calculate coordinates. If there are three or more detectors, directions (normal vectors of planes including three points) can also be calculated.

There is also a reflective marker type as a tracker. A light source-integrated camera is installed at a corner or the like of an internal area of the omnidirectional display device 11, and a position of a marker (retroreflective material) is measured.

There is also a magnetic type as a tracker. This is to detect the excitation current generated in the sensor coil by the magnetic field generated from the source and calculate the position and angle.

Regarding the posture estimation, it is conceivable to use a system that images a person with a camera that obtains an RGB image and depth (distance information) and performs image analysis. For example, for an image of a person, bone data (skeleton data) is obtained by machine learning-based estimation to estimate the posture, and the position and direction of the head are detected from the posture.

The head position/direction detection device 12 as described above is provided so that the gaze direction of the user can be calculated.

Note that, in practice, the gaze direction changes depending on not only the position and orientation of the head of the remote user 5 but also the line-of-sight direction. However, since the range of the eye movement is around 30 degrees, the region on the image including the actual gaze region of the user can be determined by roughly determining the region gazed so as to cover the range.

The site imaging system 3 is provided with the direction indication device 32 for notifying the site user 6 of the gaze region of the remote user 5. The direction indication device 32 is assumed to be presented visually, presented audibly, or provided with both of them.

For example, as ones presented visually,
Indicator needle, face of robot, face of stuffed toy, display displaying avatar front face, and the like, and rotation mechanism for directing them in arbitrary direction.
Planned planar display with avatar upper surface
Cylindrical display enabling observation of avatar from any direction

and the like are assumed.

Further, as ones presented audibly,
Directional loudspeaker array or directional loudspeaker with rotation mechanism
Headphone or earphone with built-in gyro sensor, compass, or the like and capable of reproducing three-dimensional audio and the like are assumed.

Some aspects of the site imaging system 3 will be illustrated together with specific examples of the direction indication device 32.

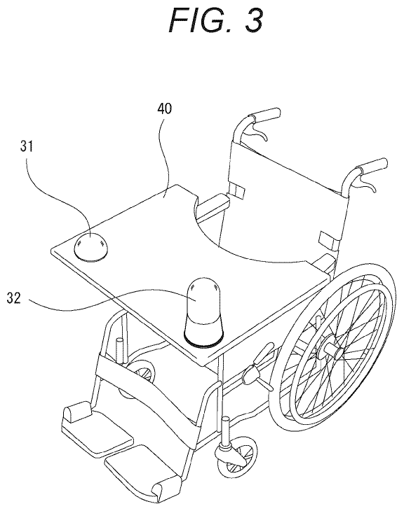

FIG. 3 illustrates an example in which the site imaging system 3 is a wheelchair type.

The omnidirectional camera 31 and the direction indication device 32 are mounted on a table provided in the wheelchair 40. The omnidirectional camera 31 and the direction indication device 32 may be attached to a seat surface or a frame instead of the table.

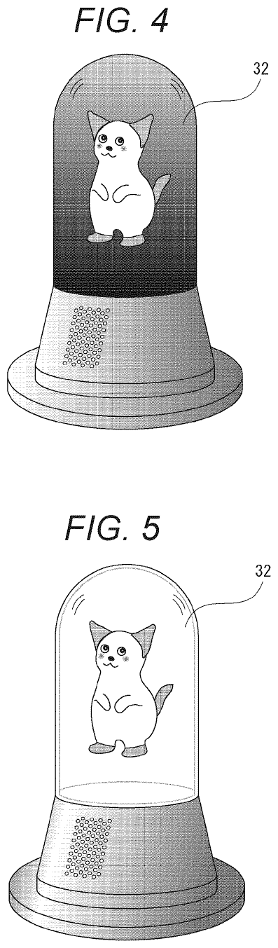

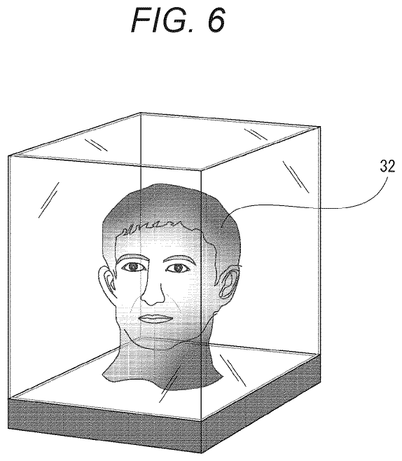

As the direction indication device 32 in this case, there is a device capable of stereoscopically displaying an avatar, a character, and the like in a cylindrical shape as illustrated in FIG. 4. Alternatively, as illustrated in FIG. 5, a transparent cylindrical shape may be used, and an avatar or the like may be displayed three-dimensionally inside. Furthermore, as illustrated in FIG. 6, a transparent face image or the like may be stereoscopically displayable.

An avatar, a character, an actual face image, or the like indicates the remote user 5. Then, the gaze direction of the remote user 5 is presented by the orientation of the face of the avatar or the like.

FIG. 7 illustrates an example in which the site imaging system 3 is configured as a backpack type.

The omnidirectional camera 31 is attached to a tip of an arm attached to the backpack 41. The direction indication device 32 is an example of a shoulder type. The direction indication device 32 can be attached to a shoulder or the like of the site user 6 as a stuffed toy, a doll, a robot, or the like. Then, a mechanism for rotating or moving the head is provided. That is, the direction of the face of the stuffed toy or the like is actually changed to present the gaze direction of the remote user 5.

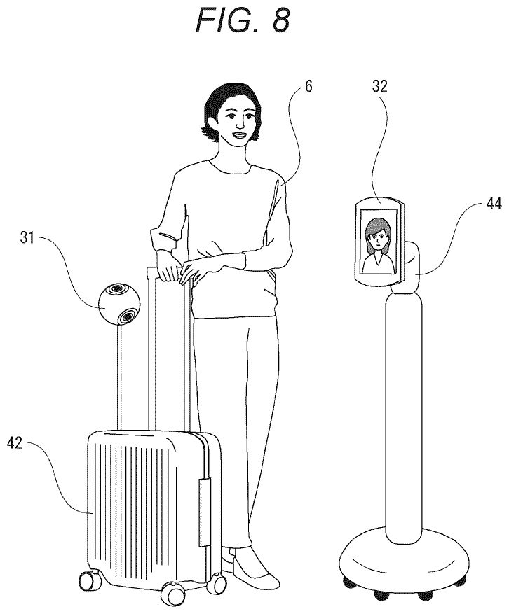

FIG. 8 illustrates an example in which the site imaging system 3 includes a carry case 42 and a self-propelled robot 44.

The omnidirectional camera 31 is attached to the tip of the arm attached to the carry case 42. The direction indication device 32 is a display panel attached to the self-propelled robot 44. The self-propelled robot 44 moves together with the site user 6, and displays an avatar or the like on the display panel. Then, the gaze direction of the remote user 5 is presented by the direction of the face of the avatar or the like.

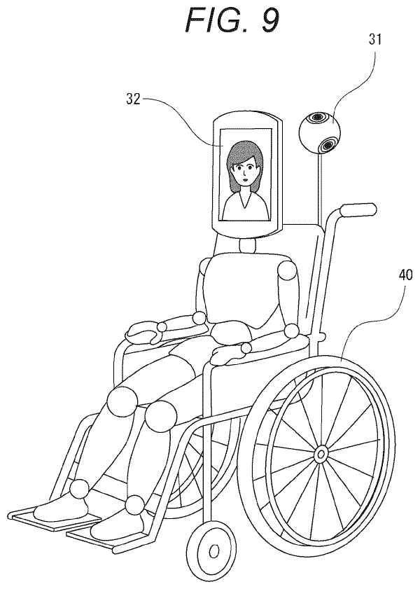

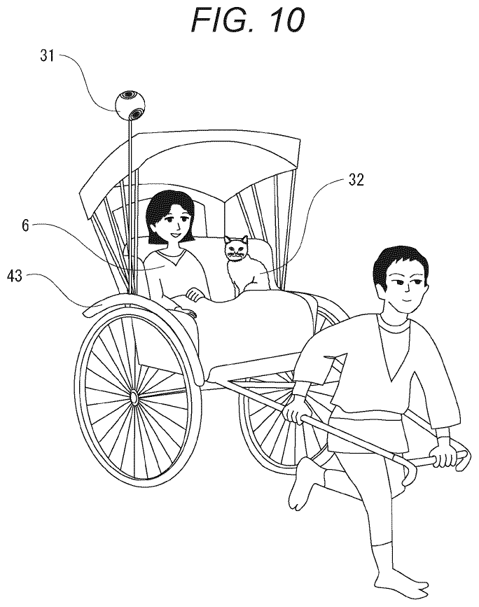

FIG. 9 illustrates an example in which the human-shaped direction indication device 32 is placed on the wheelchair 40. As a humanoid robot on the wheelchair 40, a display panel is provided on the head, and a face or the like of a person is displayed on the display panel. Then, the gaze direction of the remote user 5 is presented by the direction of the displayed face.

FIG. 10 is an example of using a human-powered vehicle 43. The omnidirectional camera 31 is attached to the human-powered vehicle 43, and the direction indication device 32 in the form of a stuffed toy, a doll, or the like is provided. For example, a stuffed toy or the like is on the human-powered vehicle 43 together with the site user 6. It is assumed that a head of a stuffed toy or the like moves up, down, left, and right. The site user 6 can know the gaze direction of the remote user 5 by the head direction of the stuffed toy or the like.

The above is merely an example, and various combinations and forms can be considered as the remote visual recognition system 1. In the doll, the stuffed toy, or the like, not only the head moves in an arbitrary direction but also the eyes may move.

For example, the remote visual recognition system 1 is not limited to the wheelchair 40, the backpack 41, the carry case 42, the human-powered vehicle 43, and the self-propelled robot 44, but may be clothing, a hat, a bicycle, an automobile, a flying object, a ship, or the like.

As a form of the direction indication device 32, a two-dimensional display, a three-dimensional display, a hologram display device, a doll, a stuffed toy, a robot, a mechanism indicating a direction by an arrow or the like, a mechanism indicating a direction by light or color, or the like may be used.

Further, the direction indication device 32 may indicate a direction by sound. In FIG. 7, the site user 6 wears the earphone 45, but this may function as the speaker 34 in FIG. 1 and convey the direction by sound.

In addition, the output directivity of the speaker 34 mounted on the wheelchair 40, the human-powered vehicle 43, the self-propelled robot 44, and the like may be controlled so that the gaze direction can be recognized by the direction of the sound.

The above example is assumed, and description will be made referring back to FIG. 1.

As illustrated in the drawing, the control terminal 10 in the remote visual recognition system 1 has functions as a display control unit 10a and a gaze information processing unit 10b.

The display control unit 10a is a function of performing display control of the omnidirectional display device 11. The display control unit 10a performs processing of causing the omnidirectional display device 11 to display the captured image of the omnidirectional camera 31 received via the communication device 21.

In a case where sound is transmitted together with an image from the site imaging system 3, the display control unit 10a performs processing of outputting the transmitted sound signal from the speaker 14.

The gaze information processing unit 10b performs processing of generating gaze direction information, which is information in a direction based on the position of the omnidirectional camera 31, on the basis of the information on the position/direction of the head of the remote user 5 detected by the head position/direction detection device 12, and transmitting the gaze direction information to the site imaging system 3.

Note that the control terminal 10 performs various types of processing in addition to the above-described processing of the display control unit 10a and the gaze information processing unit 10b.

For example, processing of transmitting a sound by the microphone 13 to the site imaging system 3, processing of transmitting operation information by the operation unit 19 to the site imaging system 3, and the like are also performed.

The control terminal 30 of the site imaging system 3 has functions as a camera control unit 30a and a direction indication control unit 30b.

The camera control unit 30a performs processing of controlling an imaging operation of the omnidirectional camera 31 and processing of transmitting a captured image by the omnidirectional camera 31 to the remote visual recognition system 1.

Examples of the control of the omnidirectional camera 31 by the camera control unit 30a include control related to exposure correction. For example, exposure correction is performed by any one of the following pieces of control processing or a combination thereof.
Shutter speed adjustment
Diaphragm adjustment
ISO sensitivity (signal amplification of image sensor) adjustment
Insert ND filter Furthermore, the camera control unit 30a can also perform focus adjustment control and white balance adjustment control.

The focus control allows the remote user 5 to view an arbitrary object on the site side in a state where the object is focused.

Furthermore, the white balance adjustment control enables the remote user 5 to view the state on the site side with more faithful color reproduction.

In particular, the camera control unit 30a performs the above exposure control, focus adjustment control, white balance adjustment control, and the like on the basis of gaze direction information from the remote visual recognition system 1.

With regard to the exposure control, based on the gaze direction information, control is performed such that the exposure of the region gazed by the remote user 5 is appropriate in the captured image of the omnidirectional camera 31. For example, it is determined whether or not the exposure of the region is appropriate with reference to the luminance of the representative point in the gaze region, the maximum value, the minimum value, the average value, and the luminance histogram of the luminance in the region, and if not appropriate, the exposure control is performed.

As a result, in the display image of the omnidirectional display device 11, an image in the direction in which the remote user 5 is gazing becomes an image captured with appropriate exposure.

For example, if the exposure is lowered by automatic exposure control or the like in a case where the omnidirectional camera 31 is capturing an image including sunlight, an image in a direction visually recognized by the remote user 5 may become a dark image due to insufficient exposure. However, by determining whether or not the exposure is appropriate in the image region visually recognized by the remote user 5 and performing exposure control, the gaze region of the remote user 5 is imaged with appropriate brightness regardless of the brightness of the surrounding scene on the site.

With regard to the focus adjustment control, based on the gaze direction information, it is possible to bring a subject at which the remote user 5 is gazing into a focus state, and the remote user 5 can view an image in an appropriate focus state.

With regard to the white balance adjustment control, for example, it is possible to cause the omnidirectional display device 11 to display an image with an appropriate color by appropriately adjusting the white balance adjustment control depending on whether the site is outdoors (under sunlight) or indoors (under illumination), and it is possible to visually recognize a subject with a color similar to that of the site user 6 by performing adjustment depending on a subject in a direction in which the remote user 5 is gazing particularly on the basis of gaze direction information.

As the transmission processing of the captured image by the camera control unit 30a, processing of transmitting an image captured by the omnidirectional camera 31, that is, a moving image captured at the site in a predetermined communication format is performed. Sound by the microphone 33 may also be transmitted simultaneously.

The direction indication control unit 30b in the control terminal 30 is a function of controlling the direction indication device 32. The direction indication control unit 30b controls the direction indication device 32 to present the gaze direction of the remote user 5 according to the gaze direction information transmitted from the remote visual recognition system 1.

For example, the direction indication control unit 30b performs processing of indicating the corresponding direction by an arrow, an avatar, or other display in the direction indication device 32. Alternatively, in a case where the direction indication device 32 is a stuffed toy or the like, the direction indication is executed by performing control to drive the head and eyes.

Furthermore, in the case of indicating the direction by sound, the direction indication control unit 30b performs processing of generating a sound signal for direction indication and causing the speaker 34 to output the sound signal.

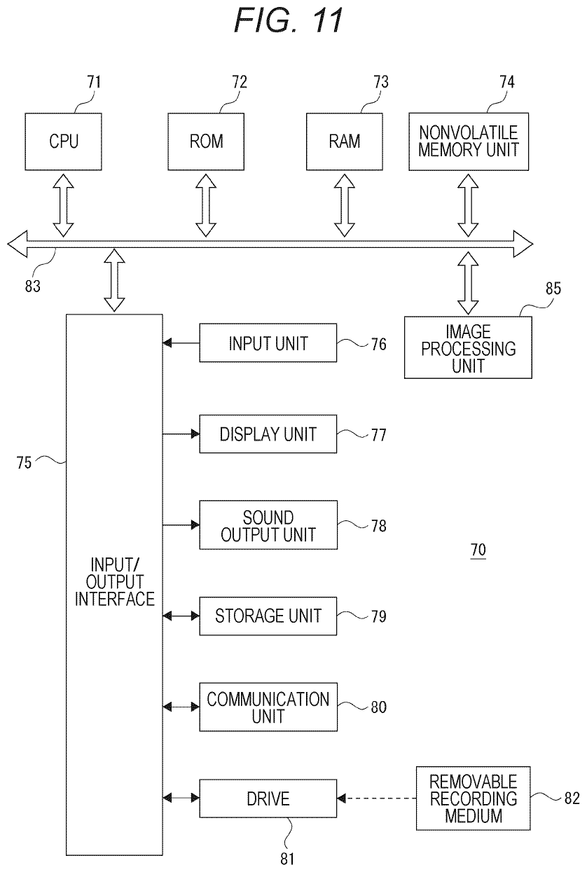

The control terminals 10 and 30 having the above-described functions can be configured by the information processing apparatus 70 as illustrated in FIG. 11, for example.

The information processing apparatus 70 is a device capable of performing information processing, such as a computer device. Specifically, a personal computer, a workstation, a portable terminal device such as a smartphone or a tablet, or the like is assumed as the information processing apparatus 70. Furthermore, the information processing apparatus 70 may be a computer apparatus configured as a server apparatus or a calculation apparatus in cloud computing.

A central processing unit (CPU) 71 of the information processing apparatus 70 illustrated in FIG. 11 executes various types of processing in accordance with a program stored in a nonvolatile memory unit 74 such as a read only memory (ROM) 72 or, for example, an electrically erasable programmable read only memory (EEP-ROM), or a program loaded from the storage unit 79 to a random access memory (RAM) 73. In addition, the RAM 73 also stores, as appropriate, data and the like necessary for the CPU 71 to perform the various types of processing.

An image processing unit 85 is implemented as a processor that performs various types of image processing. For example, the processor is a processor capable of performing any one of luminance processing, color processing, image analysis processing, image compression/expansion processing, image editing processing, stitch processing, and the like, or a plurality of types of processing.

The image processing unit 85 can be realized by, for example, a CPU separate from the CPU 71, a graphics processing unit (GPU), general-purpose computing on graphics processing units (GPGPU), an artificial intelligence (AI) processor, or the like.

Note that the image processing unit 85 may be provided as a function in the CPU 71.

The CPU 71, the ROM 72, the RAM 73, the nonvolatile memory unit 74, and the image processing unit 85 are connected to one another via a bus 83. In addition, an input/output interface 75 is also connected to the bus 83.

An input unit 76 including an operation element and an operation device is connected to the input/output interface 75. For example, as the input unit 76, various operators and operation devices such as a keyboard, a mouse, a key, a trackball, a dial, a touch panel, a touch pad, a remote controller and the like are assumed.

A user operation is detected by the input unit 76, and a signal corresponding to an input operation is interpreted by the CPU 71.

A microphone is also assumed as the input unit 76. It is also possible to input sound uttered by the user as operation information. The input unit 76 may function as, for example, the microphones 13 and 33 in FIG. 1.

In addition, a display unit 77 including a liquid crystal display (LCD), an organic electro-luminescence (EL) panel, or the like is integrally or separately connected to the input/output interface 75. The display unit 77 is a display unit that performs various displays, and includes, for example, a display device provided in a housing of the information processing apparatus 70, a separate display device connected to the information processing apparatus 70, and the like.

The display unit 77 performs display of various images, operation menus, icons, messages, and the like, that is, display as a graphical user interface (GUI), on a display screen on the basis of an instruction from the CPU 71.

In addition, a sound output unit 78 including a speaker unit or the like is connected to the input/output interface 75 integrally or separately. The sound output unit 78 may function as the speakers 14 and 34 in FIG. 1.

The storage unit 79 including a hard disk drive (HDD), a solid-state memory, or the like or a communication unit 80 may be connected to the input/output interface 75.

The storage unit 79 can store various data and programs. A data base (DB) can be configured in the storage unit 79.

The communication unit 80 performs communication processing via a transmission line such as the Internet, wired/wireless communication with various devices such as an external DB, an editing apparatus, and an information processing apparatus, and communication by bus communication and the like.

For example, the communication unit 80 can function as an interface with the communication devices 21 and 22 in FIG. 1.

A drive 81 is also connected to the input/output interface 75, as necessary, and a removable recording medium 82 such as a magnetic disk, an optical disk, a magneto-optical disk, a semiconductor memory, or the like is appropriately mounted.

The drive 81 enables image data, various computer programs, and the like to be read from the removable recording medium 82. The read data is stored in the storage unit 79, and video and sound included in the data are output by the display unit 77 and the sound output unit 78. Furthermore, the computer program and the like read from the removable recording medium 82 are installed in the storage unit 79, as necessary.

In the information processing apparatus 70, for example, the control terminal 10 of the present embodiment or software for processing of the control terminal 30 can be installed via network communication by the communication unit 80 or the removable recording medium 82. Alternatively, the software may be stored in advance in the ROM 72, the storage unit 79, or the like.

Hereinafter, a processing example as the first embodiment will be described.

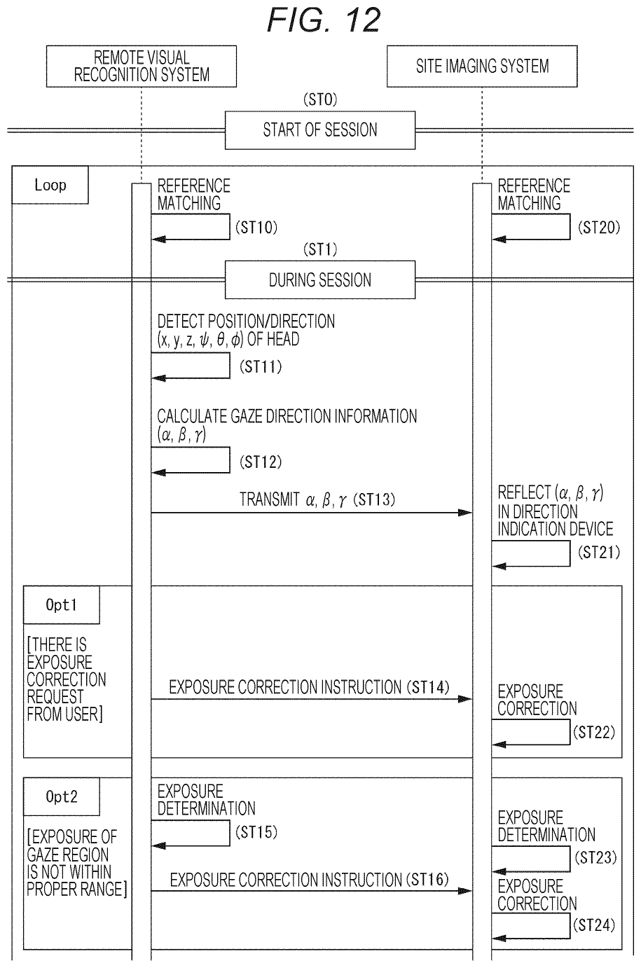

First, a flow of processing of the remote visual recognition system 1 and the site imaging system 3 will be described with reference to FIG. 12.

The remote visual recognition system 1 and the site imaging system 3 start a session at step STO.

First, the remote visual recognition system 1 performs reference matching in step ST10, and the site imaging system 3 also performs reference matching in step ST20.

The reference matching is processing of aligning the reference direction of the imaging direction of the omnidirectional camera 31 on the site side with the reference direction as the visual recognition direction of the remote user 5.

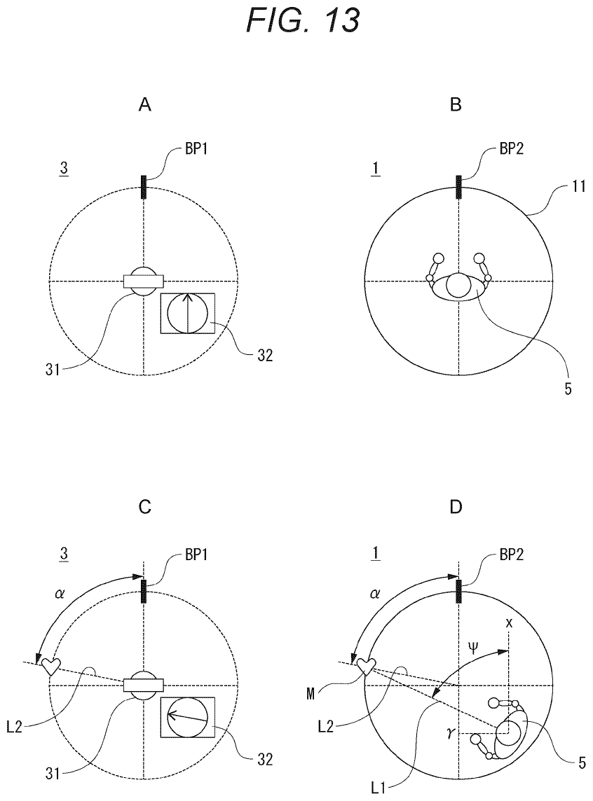

FIG. 13A illustrates a state in which the omnidirectional camera 31 is at the origin position. The center of the circle indicated by the dotted line is the origin. The omnidirectional camera 31 uses, for example, a direction of a position BP1 which is a front direction as a reference direction. For example, it is assumed that the center (the center in the horizontal direction) in the plane of the captured image of the omnidirectional camera 31 is the direction indicated by the position BP1.

FIG. 13B illustrates a state in which the remote user 5 in the internal area of the omnidirectional display device 11 is at the origin position. A circle indicated by a solid line is considered as an image display surface of the omnidirectional display device 11. The center of the circle is the origin. The remote user 5 is in a state of viewing at the direction indicated by a position BP2 of the omnidirectional display device 11, and this is set as the reference direction for the gaze direction.

The remote visual recognition system 1 and the site imaging system 3 are caused to coincide with each other with the states in FIGS. 13A and 13B as reference position states. For example, the center (subject at the position BP1) of the captured image of the omnidirectional camera 31 is displayed at the position BP2 of the omnidirectional display device 11.

As a result, the direction indication device 32 indicates the front direction when the remote user 5 is viewing forward at the origin position.

FIG. 13A schematically illustrates the direction indication device 32, and an arrow indicates the presented direction. A state in which the remote user 5 is at the origin position of the internal area of the omnidirectional display device 11 in FIG. 13B and visually recognizes the position BP is matched with a state in which the direction indication device 32 indicates the front direction as illustrated in FIG. 13A.

Note that FIGS. 13A and 13B illustrate the position in the horizontal direction (the horizontal direction (yaw direction) for the remote user 5), but the alignment is similarly performed in the vertical direction (the vertical direction (pitch direction) for the remote user 5).

After performing the reference matching, the remote visual recognition system 1 and the site imaging system 3 repeatedly execute the subsequent processing as loop processing while continuing the session as step ST1 in FIG. 12.

During the session, the captured image in the site imaging system 3 is transmitted to the remote visual recognition system 1 and displayed on the omnidirectional display device 11.

In step ST11, the remote visual recognition system 1 detects the position and direction of the head of the remote user 5. FIG. 13D illustrates a state in which the remote user 5 is at a certain position in the internal area of the omnidirectional display device 11 and is viewing a certain direction.

The coordinates of the position of the head of the remote user 5 are (x, y, z). x and y are two-dimensional coordinates in the horizontal direction, and z is a coordinate in the vertical direction.

The coordinates (x, y, z) are detected by the head position/direction detection device 12.

In addition, the head direction (ψ, θ) is obtained. ψ is a head direction viewed in the horizontal direction, and θ is a head direction viewed in the vertical direction.

Note that FIG. 13D is an expression of only a horizontal plane, and thus illustrates the coordinates (x, y) and the head direction ψ. When viewed in the vertical direction, the coordinate z and the head direction θ appear.

As described above, the coordinates (x, y, z) and the head direction (ψ, θ) are obtained as the head position. In addition, as the head direction φ, the orientation of the head in the roll direction may be detected. The roll direction is a direction of movement when the remote user 5 tilts the head.

Subsequently, in step ST12, the remote visual recognition system 1 obtains gaze direction information (α, β). This is information in a direction viewed from the reference direction of the omnidirectional camera 31 as illustrated in FIG. 13A, α is a displacement amount from the reference direction in the horizontal direction, and β is a displacement amount from the reference direction in the vertical direction.

Note that the gaze direction information (α, β, γ) may be obtained. γ indicates the head direction φ in the roll direction as a displacement amount from the normal posture state of the omnidirectional camera 31.

As illustrated in FIG. 13D, an intersection M between a line L1 of the head direction ψ starting from the coordinates (x, y, z) of the head position of the remote user 5 and the display surface is obtained, and gaze direction information α is calculated as an azimuth difference of the intersection M from the position BP2.

Then, a line L2 from the origin toward the intersection M indicates a direction toward the intersection M as viewed from the omnidirectional camera 31 as illustrated in FIG. 13C, and this indicates a direction gazed by the remote user 5 in the captured image of the omnidirectional camera 31. The direction indication device 32 indicates a direction parallel to the line L2.

Therefore, the gaze direction information α is information indicating the gaze direction of the remote user 5 with reference to the position of the omnidirectional camera 31 regardless of the coordinates (x, y, z) of the position of the remote user 5.

Note that although FIG. 13C illustrates only the gaze direction information α for expression in the horizontal direction, the gaze direction information β is similarly calculated when considered in the vertical direction.

That is, an intersection between a line of the head direction θ starting from the coordinates (x, y, z) of the head position of the remote user 5 and the display surface is obtained, and the gaze direction information β is obtained as an azimuth difference from the position BP2.

In addition, in the case of generating the gaze direction information γ, the gaze direction information γ indicating the displacement amount according to the head direction φ in the roll direction is only required to be obtained on the basis of the normal posture of the head and the normal posture of the omnidirectional camera 31.

In step ST13, the remote visual recognition system 1 transmits the gaze direction information (α, β) or the gaze direction information (α, β, γ) obtained in this manner to the site imaging system 3.

In step ST21, the site imaging system 3 reflects the gaze direction information (α, β, γ) in the direction indication device 32. That is, processing of causing an avatar, a stuffed toy, or the like in the direction indication device 32 to face the direction indicated by the gaze direction information (α, β) or transmitting the direction by sound is performed.

If the direction indication device 32 presents only the direction, the head direction φ and the gaze direction information γ in the roll direction are not necessary, but the roll direction can be presented by the direction indication device 32. For example, according to the gaze direction information γ, it is possible to express that an avatar, a stuffed toy, or the like tilts its head.

By continuously performing the processing of steps ST11, ST12, ST13, and ST21 described above, the site user 6 can recognize the direction in which the remote user 5 is gazing by the direction indication device 32.

In addition, processing indicated as options opt1 and opt2 is also performed during the session.

The option opt1 is processing according to an instruction from the remote user 5.

When the remote user 5 requests exposure correction by performing an operation or the like, the remote visual recognition system 1 transmits an exposure correction instruction to the site imaging system 3 in step ST14.

In response to this, the site imaging system 3 performs exposure correction of the omnidirectional camera 31.

The option opt2 is processing according to an instruction of the remote user 5 based on automatic determination. At step ST15, the remote visual recognition system 1 determines the exposure state of the region gazed by the remote user 5. Since the remote visual recognition system 1 can detect the gaze direction of the remote user 5, it is possible to determine whether or not the exposure is appropriate for the image of the region.

If the exposure is not appropriate, the remote visual recognition system 1 transmits an exposure correction instruction as step ST16.

Alternatively, as step ST23, the exposure state of the region gazed by the remote user 5 on the site imaging system 3 side may be determined. Since the site imaging system 3 can detect the gaze direction of the remote user 5 by receiving the gaze direction information, it is possible to determine whether or not the exposure of the captured image of the region is appropriate.

In a case where it is determined that the exposure of the region in the direction currently gazed by the remote user 5 is not appropriate on either the remote visual recognition system 1 side or the site imaging system 3 side, the site imaging system 3 performs exposure correction of the omnidirectional camera 31 in step ST24. As a result, the image gazed by the remote user 5 is displayed on the omnidirectional display device 11 in an appropriate exposure state.

As illustrated in FIG. 12, processing is performed between the remote visual recognition system 1 and the site imaging system 3, so that the remote user 5 can visually recognize a scene similar to that of the site user 6. In addition, the site user 6 can recognize the direction in which the remote user 5 is gazing by the direction indication device 32.

Furthermore, the subject in the direction gazed by the remote user 5 is displayed on the omnidirectional display device 11 in an appropriate exposure state.

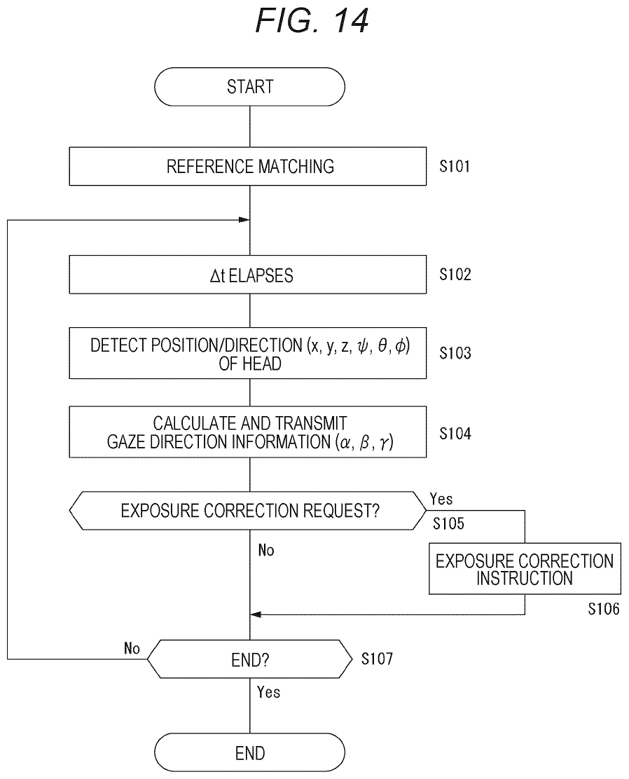

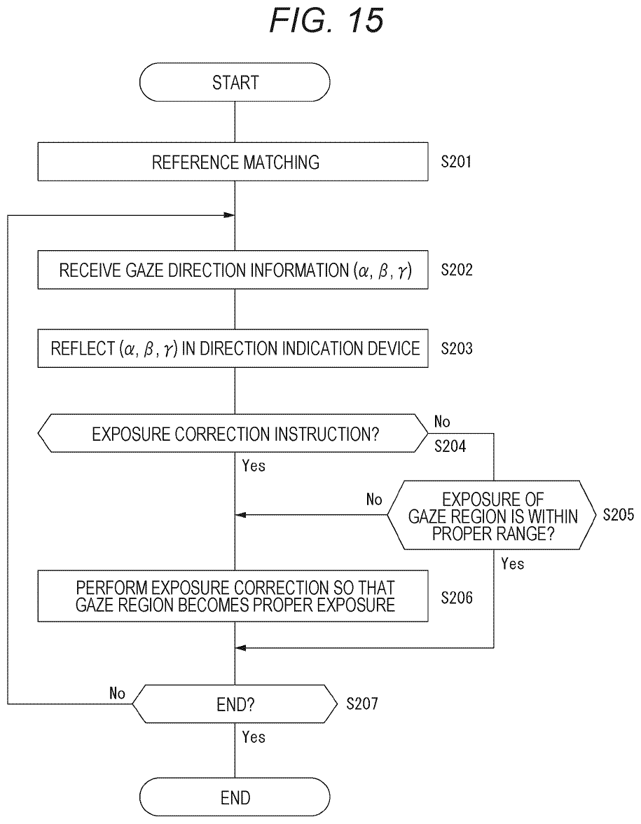

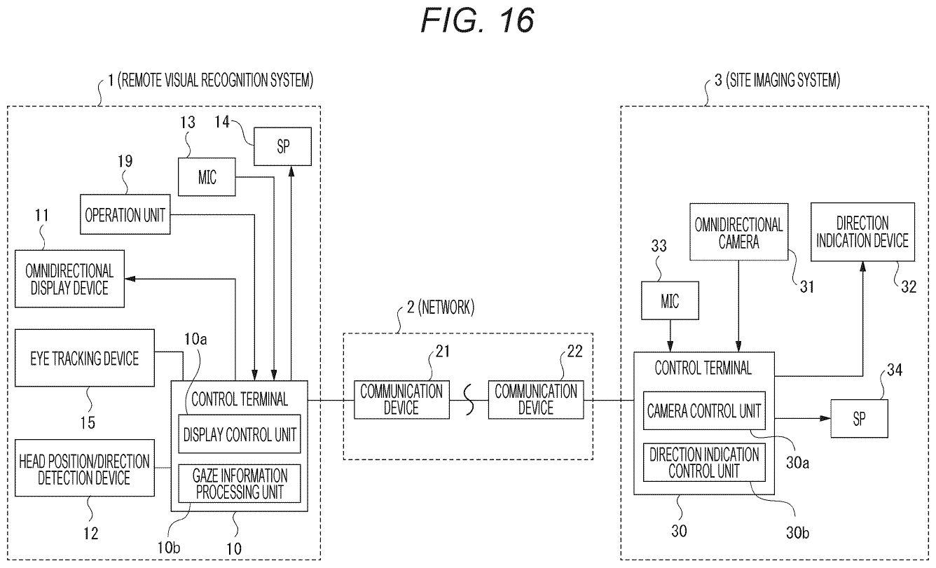

FIGS. 14 and 15 illustrate processing examples of the control terminals 10 and 30 for implementing such an operation.

FIG. 14 illustrates a processing example of the control terminal 10.

By the start of the session, the control terminal 10 starts the processing in FIG. 14.

Note that transmission of the captured video from the site imaging system 3 is started by the start of the session, and the image received by the omnidirectional display device 11 is displayed by the function of the display control unit 10a of the control terminal 10, but this processing is continued until the session ends, and is not illustrated in the flowchart. FIG. 14 mainly illustrates processing by the function of the gaze information processing unit 10b and processing corresponding to a user operation.

After the start of the session, the control terminal 10 first performs the reference matching described above in step S101.

During the session, the control terminal 10 performs the processing in and after step S103, for example, every time the waiting time At elapses in step S102.

In step S103, the control terminal 10 detects the position and direction of the head. That is, the control terminal 10 acquires detection information from the head position/direction detection device 12.

In step S104, the control terminal 10 performs processing of calculating the gaze direction information (α, β) or the gaze direction information (α, β, γ) using the acquired detection information, and transmitting the calculated gaze direction information.

The above is the processing described in steps ST11, ST12, and ST13 in FIG. 12.

In step S105 in FIG. 14, the control terminal 10 determines whether or not there is an exposure correction request by the remote user 5. For example, it is determined whether or not the remote user 5 has operated the operation unit 19 to make an exposure correction request.

In a case where there is an exposure correction request, the control terminal 10 transmits an exposure correction instruction to the site imaging system 3 in step S106.

This is processing corresponding to the option opt1 in FIG. 12.

The control terminal 10 repeatedly executes steps S102 to S106 in FIG. 14 until the session ends in step S107.

Note that the control terminal 10 may or may not perform the exposure determination or the exposure correction instruction as the option opt2 in FIG. 12. In FIGS. 14 and 15, since the exposure determination is performed on the site imaging system 3 side, although not illustrated in FIG. 14, for example, the control terminal 10 may repeatedly perform the exposure determination until the session ends in step S107 and issue an exposure correction instruction as necessary.

FIG. 15 illustrates a processing example of the control terminal 30.

By the start of the session, the control terminal 30 starts the processing in FIG. 15.

Note that, by the start of the session, the control terminal 30 starts imaging by the omnidirectional camera 31 and starts processing of transmitting the captured image to the remote visual recognition system 1. This processing is continued until the session ends, and is not illustrated in the flowchart.

FIG. 15 mainly illustrates exposure control processing by the camera control unit 30a and control processing by the direction indication control unit 30b.

After the start of the session, the control terminal 30 first performs the reference matching described above in step S201.

During the session, the control terminal 10 repeatedly executes, for example, the processing from step S202 to step S206.

In step S202, the control terminal 30 receives the gaze direction information (α, β) or the gaze direction information (α, β, γ).

In step S203, the control terminal 30 performs control to reflect the gaze direction information in the direction indication device 32. That is, the control terminal 30 controls the direction indication device 32 to present the direction according to the gaze direction information (α, β). When the gaze direction information γ is included, the direction indication device 32 performs control to present a state in which the head is tilted by the displacement amount of the gaze direction information γ.

This is the processing of step ST21 in FIG. 12.

In step S204 in FIG. 15, the control terminal 30 determines whether or not there is an exposure correction instruction from the control terminal 10.

For example, in a case where the control terminal 10 has transmitted the exposure correction instruction in the processing of step S106 in FIG. 14, the control terminal 30 determines that the exposure correction instruction has been given and proceeds to step S206.

In a case where there is no exposure correction instruction, the control terminal 30 proceeds to step S205 and performs exposure determination. That is, it is determined whether or not the region in the direction of the subject indicated by the gaze direction information is in an appropriate exposure state.

The control terminal 30 sets an image region of a certain degree of in-plane range including the direction indicated by the gaze direction information (α, β) in the captured image, and determines whether or not the exposure of the region is appropriate with reference to the luminance of the representative point in the image region, the maximum value, the minimum value, the average value, and the luminance histogram.

As a result of the determination, if the exposure is not appropriate, the control terminal 30 proceeds to step S206. If the exposure is appropriate, the process proceeds to step S207 without going through step S206.

In a case where the process proceeds from step S204 or step S205 to step S206, the control terminal 30 performs exposure correction so that the captured image of the gaze region is appropriately exposed. That is, for the omnidirectional camera 31, adjustment control for bringing exposure into an appropriate state is performed by any one of shutter speed adjustment, diaphragm adjustment, ISO sensitivity adjustment, ND filter insertion, and the like, or combined control.

Steps S204 to S206 described above are pieces of processing corresponding to steps ST22, ST23, and ST24 in FIG. 12.

The control terminal 30 repeatedly executes the processing in and after step S202 until the session ends in step S207 in FIG. 15.

Note that, in this example, the exposure determination is performed in step S205, but as described with reference to FIG. 12, in a case where the exposure determination is performed on the remote visual recognition system 1 (control terminal 10) side, the processing in step S205 may not be performed.

However, even in a case where the exposure determination is performed on the remote visual recognition system 1 (control terminal 10) side, the processing of step S205 may be performed on the control terminal 30 side.

The control terminal 10 and the control terminal 30 perform the processing in FIGS. 14 and 15 described above, the linkage operation between the systems as illustrated in FIG. 12 is implemented.

Note that the control terminal 30 may perform focus determination and white balance determination on the gaze region indicated by the gaze direction information in step S205 in FIG. 15.

In this case, when defocus is detected in the gaze region, for example, focus adjustment control is performed in step S206 to bring the subject gazed by the remote user 5 into a focus state.

Furthermore, in a case where it is detected that the white balance is not appropriate, the white balance control is performed so that the hue of the image visually recognized by the remote user 5 is made as equal as possible to the hue of the scene viewed by the site user 6.

Note that the focus determination of the gaze region of the image may be performed on the control terminal 10 side, and a focus adjustment instruction may be transmitted to the control terminal 30 according to the determination.

Furthermore, the remote user 5 may be allowed to perform focus and white balance operations using the operation unit 19, and the control terminal 10 may transmit a focus adjustment instruction and a white balance adjustment instruction to the control terminal 30 in step S106 in response to detection of such an operation in step S105 in FIG. 14. In this case, the control terminal 30 performs focus adjustment control and white balance adjustment control according to the instruction.

### 2. Second Embodiment

A second embodiment will be described. FIG. 16 illustrates a configuration example. In this example, an eye tracking device 15 is provided in the remote visual recognition system 1.

The eye tracking device 15 is provided to detect the gaze position of the remote user 5 with respect to the display screen of the omnidirectional display device 11 in combination with the head position/direction detection device 12.

Examples of the eye tracking device 15 include a stationary type and a wearable type.

The eye tracking device 15 images an image of a pupil illuminated with infrared rays by, for example, a monocular or stereo camera, and detects a line-of-sight direction from a pupil position or a virtual image (Purkinje image) position based on corneal reflection. The pupil position is detected by the dark pupil method/bright pupil method.

It is conceivable that the line-of-sight direction of the remote user 5 detected by the eye tracking device 15 is reflected in the gaze direction information in the following two ways.

One is a method of correcting the head direction obtained by the head position/direction detection device 12 with the line-of-sight direction obtained by the eye tracking device 15.

In this way, for example, even if the eye line of the stuffed toy or the avatar is fixed to the front by the direction indication device 32, it is possible to perform display so as to present the line-of-sight direction in the orientation of the head. In particular, by correcting the head direction with the line-of-sight direction, the gaze direction information (α, β) can more accurately indicate the gaze direction of the remote user 5.

The other is a method of transmitting the head direction obtained by the head position/direction detection device 12 and the line-of-sight direction obtained by the eye tracking device 15 to the site imaging system 3 as separate information.

In the direction indication device 32, if the stuffed toy, the avatar, or the like can move the eyeball together with the head movement, the head direction can be reflected to the head movement of the avatar or the like, and the line-of-sight direction can be reflected to the eyeball movement. As a result, the state of the remote user 5 can be more faithfully conveyed to the site user 6.

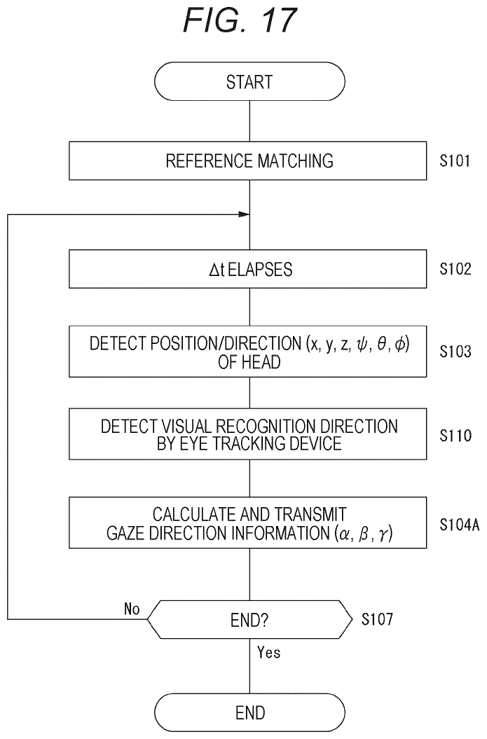

FIG. 17 illustrates a processing example of the control terminal 10.

Note that, in the following flowcharts, the same step numbers are assigned to the above-described pieces of processing, and redundant description is avoided.

In the processing example in FIG. 17, the control terminal 10 acquires the detection value from the head position/direction detection device 12 in step S103, and acquires the detection information of the line-of-sight direction by the eye tracking device 15 in step S110.

Then, in step S104A, gaze direction information is generated and transmitted to the site imaging system 3. It is assumed that the gaze direction information in this case reflects the information from the eye tracking device 15 as described above.

### 3. Third Embodiment

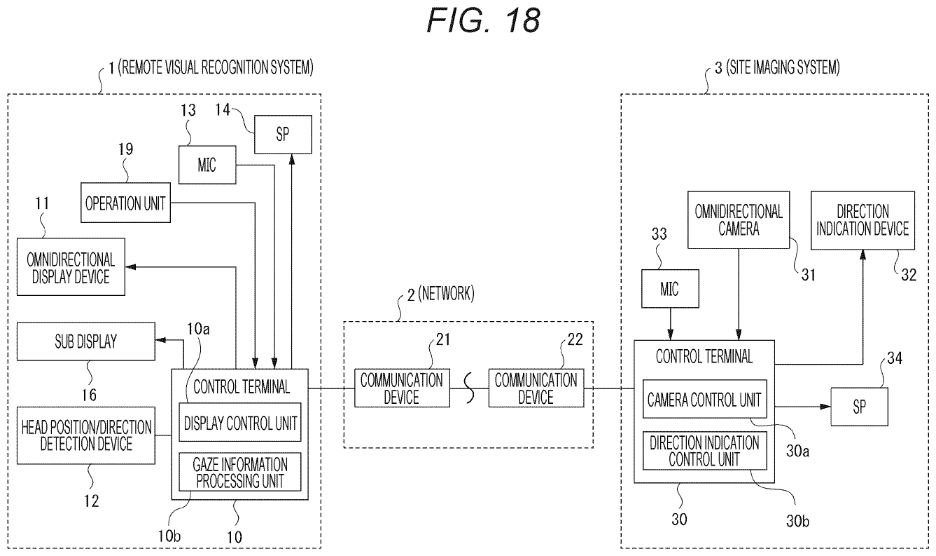

A configuration example of a third embodiment is illustrated in FIG. 18. In this example, a sub display 16 is provided in the remote visual recognition system 1.

The sub display 16 is assumed to be portable by the remote user 5, for example, as a tablet terminal, a smartphone, a small notebook PC, or the like.

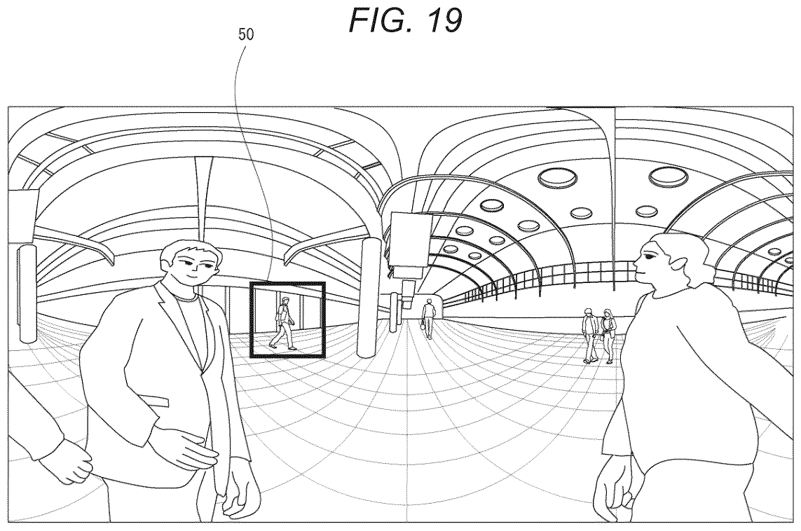

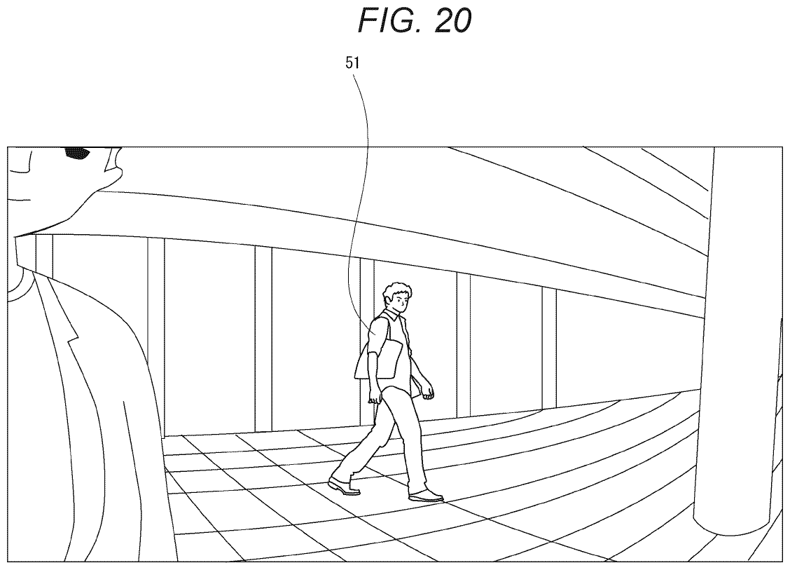

FIG. 19 is an image expressed by equirectangular projection for explaining an omnidirectional image captured by the omnidirectional camera 31 of the site imaging system 3.

It is assumed that the remote user 5 gazes around a portion indicated by a frame 50 in the drawing with respect to such an image. The control terminal 10 can determine the direction in which the remote user 5 is gazing from the detection result of the head position/direction detection device 12. Therefore, the control terminal 10 generates a rectilinear image obtained by cutting out a region gazed by the remote user 5 in the video transmitted from the site imaging system 3, and displays the rectilinear image on the sub display 16. For example, the image is as illustrated in FIG. 20.

The remote user 5 can designate a more detailed gaze point by a touch operation or the like while viewing the image as illustrated in FIG. 20 on the sub display 16 at hand.

Note that, when the remote user 5 views the sub display 16, the remote user 5 moves the head to gaze at the sub display 16 at hand. Therefore, it is appropriate that the control terminal 10 temporarily turns off the detection by the head position/direction detection device 12.

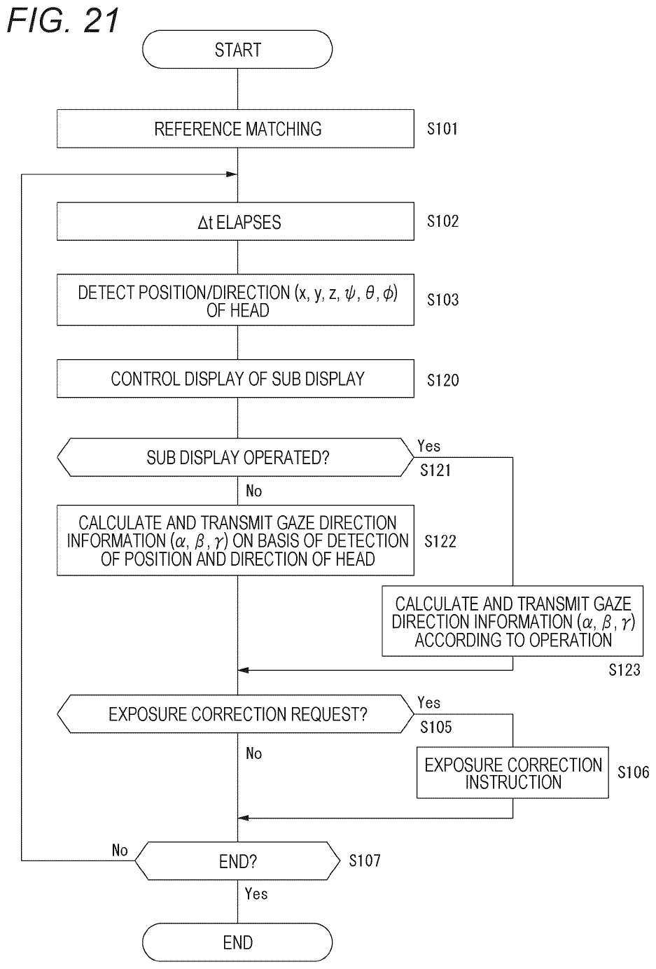

A processing example of the control terminal 10 is illustrated in FIG. 21.

When the detection result by the head position/direction detection device 12 is acquired in step S103, the control terminal 10 performs display control of the sub display 16 in step S120.

That is, when acquiring the coordinates (x, y, z) of the position of the head and the head direction (ψ, θ) or (ψ, θ, φ), the control terminal 10 determines the gaze direction of the remote user 5, generates a rectilinear image according to the gaze direction, and displays the rectilinear image on the sub display 16.

In step S121, the control terminal 10 determines whether or not the remote user 5 has performed an operation input to the sub display 16.

When the remote user 5 is not operating the sub display 16, the control terminal 10 proceeds to step S122, generates gaze direction information (α, β) or (α, β, γ) on the basis of the head position/direction detection in step S103 described above, and transmits the gaze direction information (α, β) or (α, β, γ) to the site imaging system 3.

In a case where the remote user 5 operates the sub display 16, the control terminal 10 proceeds from step S121 to step S122, generates gaze direction information (α, β) or (α, β, γ) according to the position designated by the operation on the sub display 16, and transmits the gaze direction information (α, β) or (α, β, γ) to the site imaging system 3. Note that, also in this case, the gaze direction information γ is based on the head direction φ in the roll direction.

The other pieces of processing are similar to those in FIG. 14.

By the processing in FIG. 21, in a case where the remote user 5 performs an operation on the sub display 16 at hand, the gaze direction information can be transmitted to the site imaging system 3 as more accurate information (information indicating the direction designated by the remote user 5).

Note that, as described above, when the remote user 5 views the sub display 16, the head is directed to the sub display 16, and thus, the detection result by the head position/direction detection device 12 at that time does not indicate the gaze direction with respect to the omnidirectional display device 11. Therefore, for example, in a case where it can be determined from the movement of the head that the remote user 5 views the sub display 16, it is appropriate not to use the detection result by the head position/direction detection device 12 in step S122 for generation of the gaze direction information.

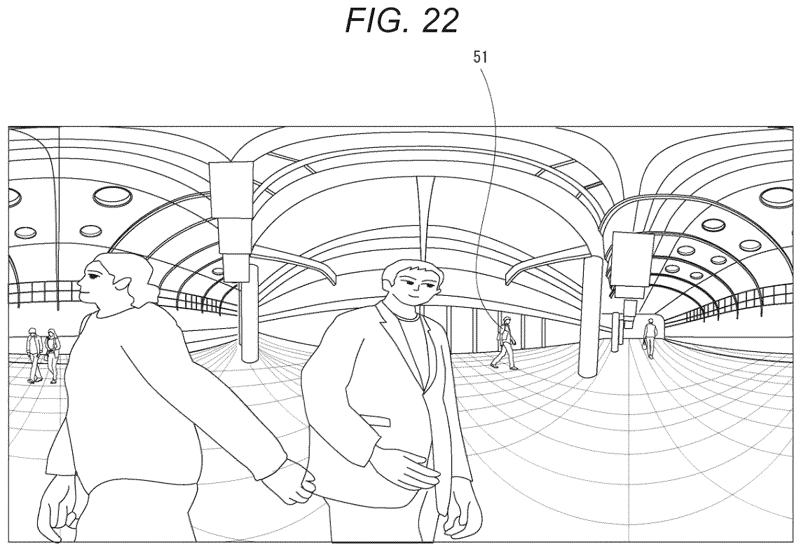

Meanwhile, the control terminal 10 may cause the sub display 16 to display an equirectangular projection scrolled so that the gaze region comes to the center instead of the cut-out rectilinear image. FIG. 22 illustrates an example of an image displayed on the sub display 16. This is an equirectangular projection image in a state where the remote user 5 has scrolled so that, when the remote user 5 gazes around the frame 50 in FIG. 19, the region is at the center.

### 4. Fourth Embodiment

In the fourth embodiment, actions (emotions and behaviors) of the remote user 5 can be expressed in the site imaging system 3.

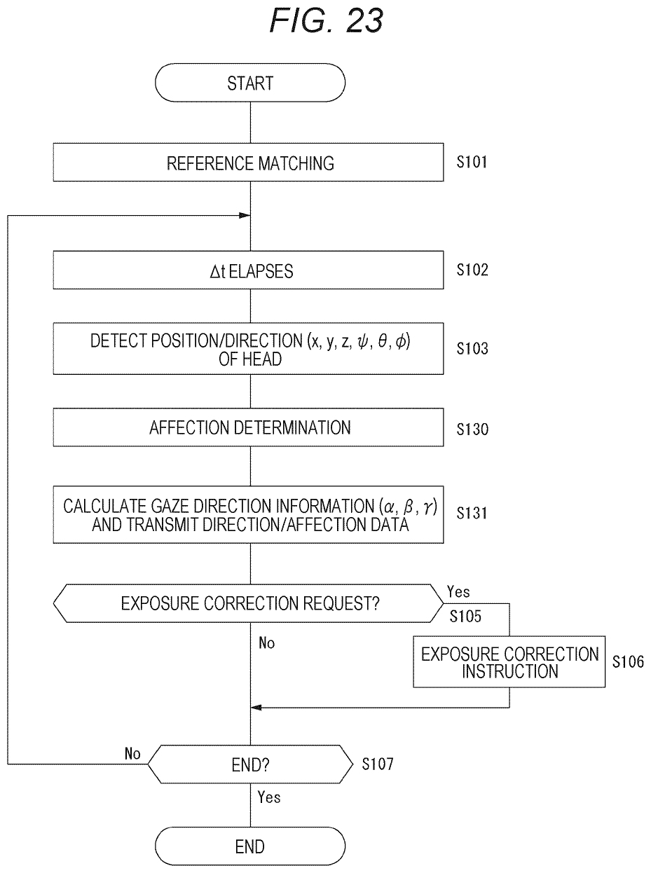

FIG. 23 is a processing example of the control terminal 10. Following the processing of steps S102 and S103, the control terminal 10 performs the affection determination in step S130.

The affection determination is processing of determining the affection and behavior of the remote user 5.

Examples of the determination of the behavior of the remote user 5 with respect to the omnidirectional display device 11 include the following determination methods.
A camera is provided in an internal area of the omnidirectional display device 11, a captured image of the remote user 5 is analyzed, posture detection is performed using bone data, and a behavior is determined from the posture.
The movement is determined by the transition of the position detection by the head position/direction detection device 12.

Examples of the determination of the emotion of the remote user 5 include the following determination methods.
The emotion is estimated by the magnitude, intonation, height, language recognition, and the like of the sound detected by a microphone 13.
A camera is provided in an internal area of the omnidirectional display device 11, and a face image of the remote user 5 is analyzed to perform expression determination and emotion estimation.
The operation unit 19 enables the remote user 5 to perform an emotion selection operation, and the remote user 5 inputs his/her emotion.
The above behavior determination is used for emotion estimation.

For example, the control terminal 10 determines the affection of the remote user 5 by these methods and generates affection data. The affection data is information indicating emotions such as smiling, happy, sad, and angry, gestures such as raising a hand, spreading a hand, pointing a finger, crossing an arm, shaking a neck from side to side, and nodding, and behaviors such as jumping and running around.

In step S131, the control terminal 10 generates gaze direction information on the basis of the detection in step S103. Then, the control terminal 10 performs processing of transmitting the gaze direction information and the affection data to the site imaging system 3.

The others are similar to those in FIG. 14.

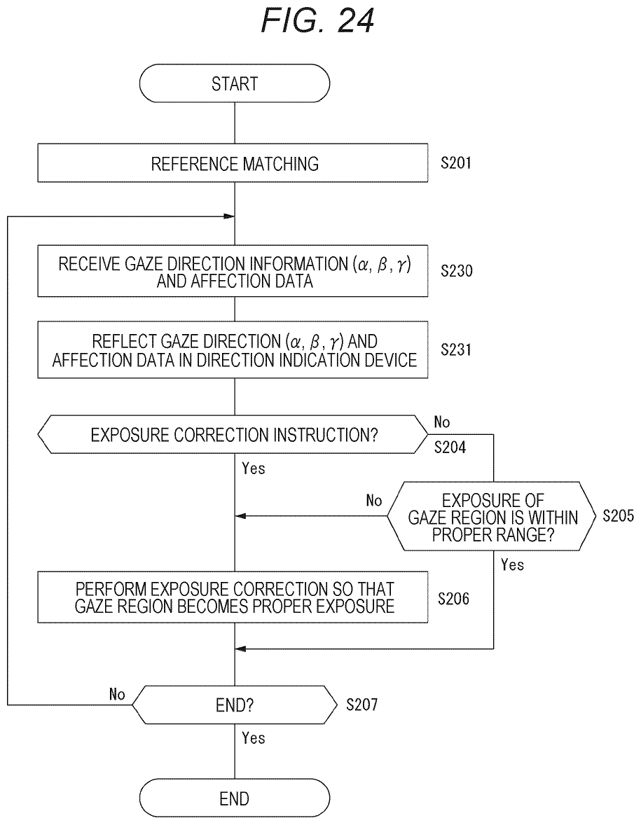

FIG. 24 is a processing example of the control terminal 30.

The control terminal 30, in step S230, the control terminal 30 receives the gaze direction information and the affection data.

Then, in step S231, the control terminal 30 performs control to reflect the gaze direction information in the direction indication device 32 and also performs control to reflect the affection data in the direction indication device 32.

First, the control terminal 30 controls the direction indication device 32 to perform presentation of a direction according to the gaze direction information or presentation of tilting the head.

In addition, the control terminal 30 controls the direction indication device 32 to express the emotion and behavior indicated by the affection data.

For example, an expression of an avatar, a stuffed toy, or the like is changed according to an emotion such as smiling, happy, sad, or angry. In addition, an avatar, a stuffed toy, or the like is caused to execute gesture and movement.

As a matter of course, the speaker 34 may output a sound according to the affection.

The other processing in FIG. 24 is similar to that in FIG. 15.

By the control terminals 10 and 30 performing the processing in FIGS. 23 and 24, the affection of the remote user 5 is transmitted to the site user 6 even expressed in the direction indication device 32. As a result, the site user 6 can move on site while understanding the emotion of the remote user 5.

### 5. Fifth Embodiment

A fifth embodiment is an example in which the remote user 5 can operate the display of the omnidirectional display device 11.

For example, a 3D mouse, a joystick, or the like is provided as the operation unit 19 so that the remote user 5 can rotate (scroll) the screen of the omnidirectional display device 11 in the yaw/pitch direction. It is preferable to change the localization of the sound according to the scrolling of the image.

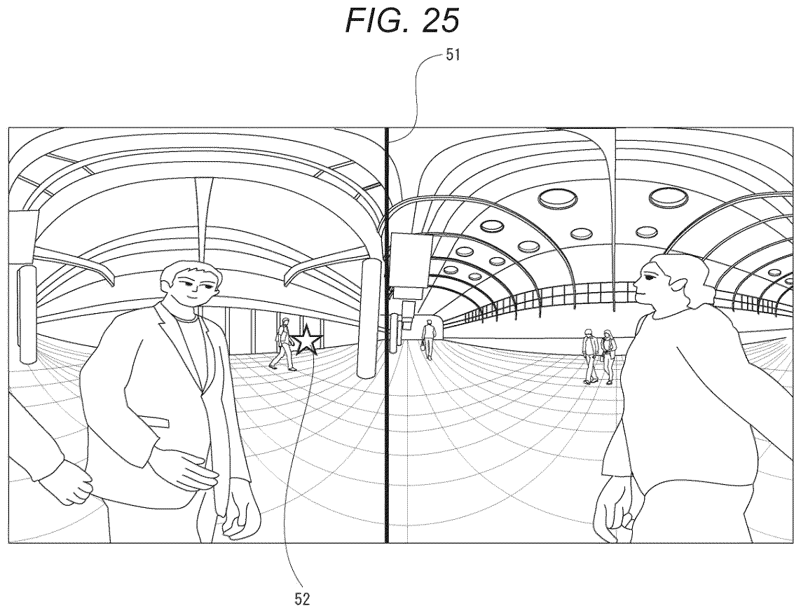

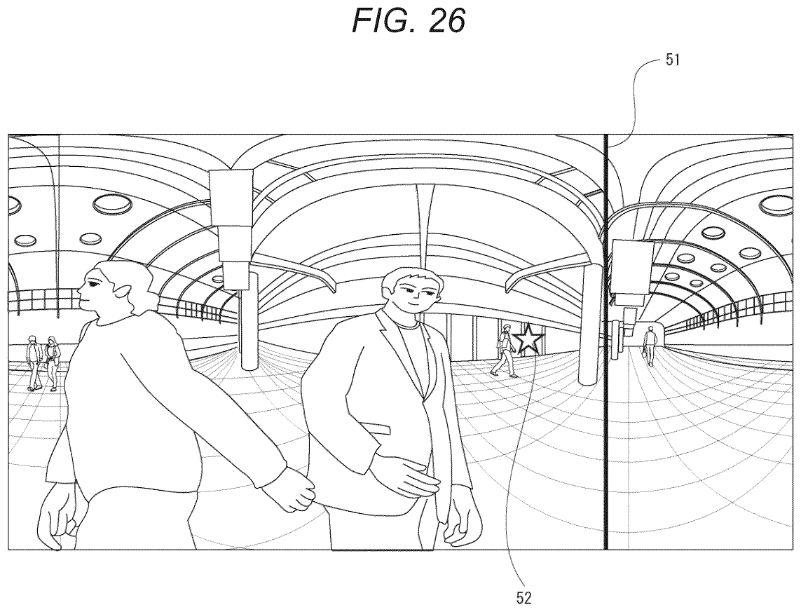

FIG. 25 is an example of an image before operation, and FIG. 26 illustrates a state in which the image is rotated in the yaw direction by the operation. A line 51 indicates, for example, the front direction of the captured image. FIG. 26 illustrates a state in which the front direction indicated by the line 51 is displaced rightward.

By enabling the operation in this manner, the remote user 5 can view a video in a direction desired to be viewed in a posture of the remote user 5 which is preferred by the remote user 5. For example, even in a case where the remote user 5 sits on a chair in an internal area of the omnidirectional display device 11 or in a case where the remote user 5 sits on a wheelchair, the remote user 5 can easily gaze at a desired portion.

However, in a case where the display of the omnidirectional display device 11 is rotated in this manner, the gaze direction information transmitted to the site imaging system 3 needs to be corrected according to the rotation operation amount and direction.

For example, it is assumed that the remote user 5 gazes around a portion indicated by a star mark 52 in FIG. 25. Then, it is assumed that the remote user 5 rotates the display image of the omnidirectional display device 11 by −90 degrees in the yaw direction by the operation.

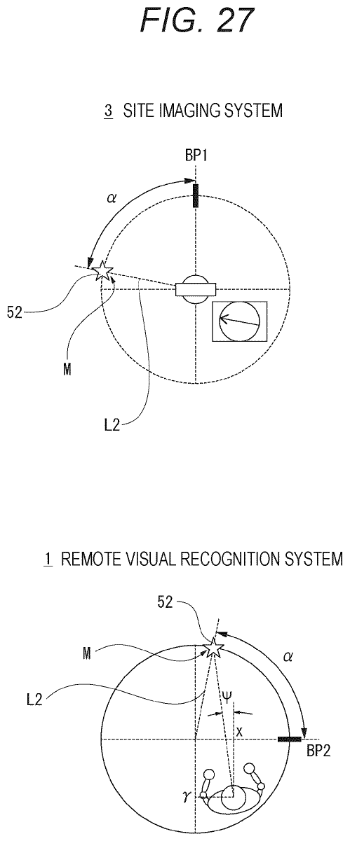

In this case, as illustrated on the remote visual recognition system 1 side in FIG. 27, the reference position BP2 is a position rotated by −90 degrees in the yaw direction. Then, the intersection M between the line L1 of the head direction (ψ, θ) starting from the coordinates (x, y, z) of the head position of the remote user 5 and the display surface is obtained. This is the position of the star mark 52. Then, gaze direction information based on the omnidirectional camera 31 is calculated by the line L2 from the origin toward the intersection M. This is the gaze direction information α in the yaw direction.

As illustrated on the site imaging system 3 side in the drawing, the gaze direction information α indicates a direction toward the intersection M as viewed from the omnidirectional camera 31, and this indicates a direction in which the remote user 5 is gazing in the captured image of the omnidirectional camera 31. The direction indication device 32 indicates a direction parallel to the line L2.

Although only the yaw direction has been described above, the similarity applies to the pitch direction.

That is, in case where the remote user 5 arbitrarily rotates the image, the control terminal 10 generates gaze direction information in consideration of the rotation, so that the site imaging system 3 can correctly present the gaze direction of the remote user 5.

### 6. Sixth Embodiment

A sixth embodiment is an example in which the transmission data amount of the captured image by the omnidirectional camera 31 can be reduced.

The remote user 5 visually recognizes the image in the gaze direction indicated by the gaze direction information in the image of the omnidirectional display device 11. In other words, images in other directions are not visible. Then, it can be said that the image of the region that is not visible to the remote user 5 does not need to be a very high-definition image.

Therefore, the captured image of the omnidirectional camera 31 is compressed and transmitted with the compression rate being different for each region.

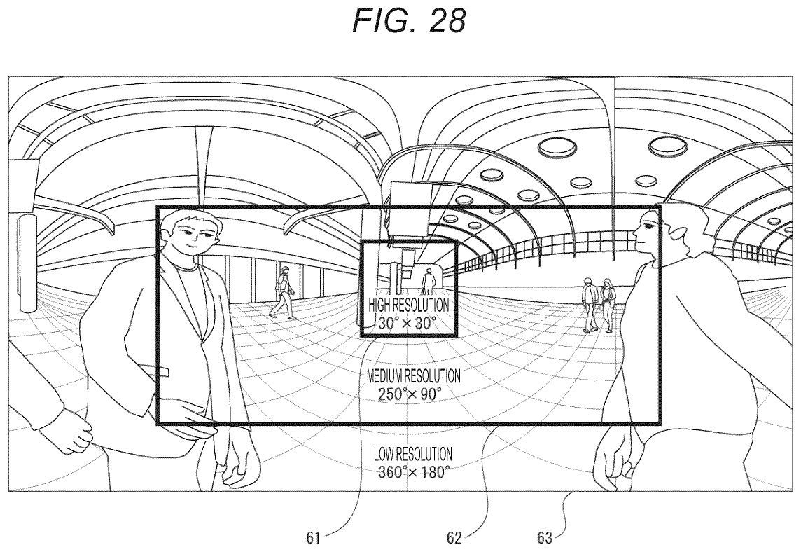

FIG. 28 illustrates an example. FIG. 28 illustrates the captured image of the omnidirectional camera 31. A range of 30 degrees×30 degrees centered on the gaze direction determined from the gaze direction information is defined as an area 61, a range of 250 degrees×90 degrees around the area 61 is defined as an area 62, and a range of 360 degrees×180 degrees around the area 62 is defined as an area 63.

The area 61 has the lowest compression rate as a high-resolution region.

The area 62 has the medium compression rate as a medium resolution region.

The area 61 has the highest compression rate as a low-resolution region.

In this manner, the control terminal 30 sets the in-plane areas 61, 62, and 63 of the captured image on the basis of the gaze direction information, sets the compression rate for each of the areas 61, 62, and 63, performs compression encoding, and transmits the compression encoding to the remote visual recognition system 1.

As a result, the bit rate of the moving image to be transmitted can be lowered.

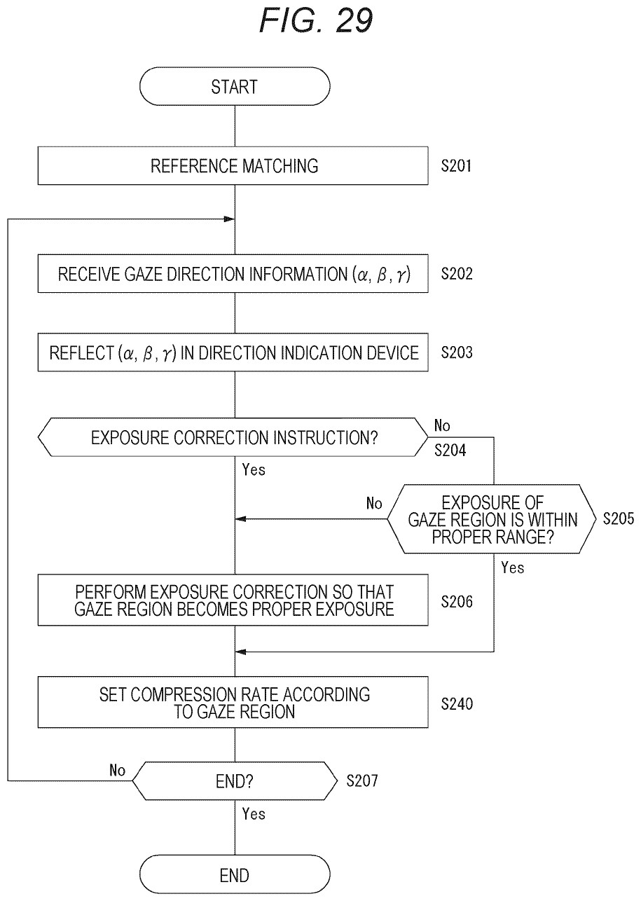

A processing example of the control terminal 30 is illustrated in FIG. 29. This is obtained by adding step S240 to the processing in FIG. 15.

In step S240, the control terminal 30 sets the plurality of areas 61, 62, and 63 on the basis of the gaze direction information received in step S202, and sets the compression rate for each area.

According to this setting, for each frame of the moving image to be transmitted, compression processing at different compression rates is performed for each area in the plane and transmitted.

Note that, since the plurality of areas is set on the basis of the gaze direction information, the area setting is updated for each frame or for each predetermined number of frames. That is, when the gaze direction of the remote user 5 changes, the area setting also changes.

In addition, the plurality of areas having different compression rates is not limited to three areas as in the areas 61, 62, and 63 in FIG. 28, and may be two areas or may be divided into four or more areas.

### 7. Plurality of Remote Users 5

Meanwhile, the processing of the first to sixth embodiments may include one or a plurality of remote users 5. However, in the above description, it has been described that the gaze direction information of one remote user 5 is transmitted to the site imaging system 3.

In a case where a plurality of remote users 5 visually recognizes the omnidirectional display device 11 in the remote visual recognition system 1, the processing of each embodiment can be applied as follows.

For example, it is conceivable that a plurality of direction indication devices 32 is provided in the site imaging system 3, and the site users 6 and the direction indication devices 32 are associated 1:1. In this case, the remote visual recognition system 1 detects the head position and direction of each site user 6 and generates and transmits a plurality of pieces of gaze direction information corresponding to each site user 6.

The site imaging system 3 side controls the corresponding direction indication devices 32 according to each gaze direction information.

As a result, the site user 6 can know the gaze direction, the affection, and the like of each of the plurality of remote users 5.

In a case where the number of the direction indication devices 32 is one and one direction indication device 32 corresponds to only one person, it is conceivable to select one of the plurality of remote users 5.

The processing of the embodiment may be performed on a specific site user 6 determined in advance.

Furthermore, for example, a person close to the central position of the internal area of the omnidirectional display device 11 may be selected, and the processing of the embodiment may be performed using the person as the remote user 5 to be processed.

In addition, it is conceivable that a person to be processed as the remote user 5 is selected while being fixedly or dynamically changed under some condition.

### 8. Summary and Modification

In the above embodiments, the following effects can be obtained.

In the first to sixth embodiments, the remote visual recognition system 1 includes the omnidirectional display device 11 that displays an image wider than a visual field range of a person, the head position/direction detection device 12 that detects the position and direction of the head of the viewer (remote user 5) of the omnidirectional display device 11, and the control terminal 10 as a control device. The control terminal 10 performs processing of causing the omnidirectional display device 11 to display the captured image at the remote location transmitted from the site imaging system 3. In addition, the control terminal 10 performs processing of generating gaze direction information on the basis of information on the position and direction of the head of the viewer by the head position/direction detection device 12 and transmitting the gaze direction information to the site imaging system 3.

The site imaging system 3 includes the omnidirectional camera 31 as an imaging device that captures an image wider than a visual field range of a person, the direction indication device 32 that indicates a direction, and the control terminal 30 as a control device. The control terminal 30 performs processing of transmitting the captured image of the omnidirectional camera 31 to the remote visual recognition system 1. In addition, the control terminal 30 performs processing of controlling an instruction direction by the direction indication device 32 on the basis of the gaze direction information of the viewer of the omnidirectional display device 11 in the remote visual recognition system 1.

Therefore, the remote user 5 who uses the remote visual recognition system 1 can visually recognize a scene on the site which is a remote location. The site user 6 using the site imaging system 3 can know in which direction the remote user 5 in the remote visual recognition system 1 is gazing at the scene on the site.

Therefore, the gaze direction can be shared between the site user 6 and the remote user 5 for a trip, an event, or the like, and a situation in which the same thing is viewed can be created. Therefore, it is possible to obtain an experience in which the remote user 5 travels together with the site user 6.

In addition, sharing the site space in a pseudo manner also contributes to good communication between the site user 6 and the remote user 5.

For example, it is possible to experience that a person at home, a person at a hospital, or the like is traveling together with an acquaintance.

In the first to sixth embodiments, the gaze direction information is information indicating the gaze direction of the remote user 5 obtained by the position and direction of the head in a direction based on the position of the omnidirectional camera 31 of the site imaging system 3 (see FIG. 13).

As a result, on the site imaging system 3, it can be determined which region of the image the remote user 5 viewing the omnidirectional display device 11 on the remote visual recognition system 1 side is gazing at as the direction from the omnidirectional camera 31. Therefore, the control terminal 30 can correctly determine the gaze region of the remote user 5 in the captured image of the omnidirectional camera 31.

In the first to sixth embodiments, an example has been described in which the omnidirectional display device 11 is a display device in which one or a plurality of viewers can visually recognize a display image by arbitrarily moving the position (see FIG. 2).

One or a plurality of remote users 5 can visually recognize an image from the site at an arbitrary position or while moving with respect to the omnidirectional display device 11 having a large image display surface on the remote visual recognition system 1 side. This makes it easier to feel the site space in a pseudo manner.

In the first to sixth embodiments, the control terminal 30 controls the omnidirectional camera 31 on the basis of the gaze direction information received from the remote visual recognition system 1.

The site imaging system 3 causes the camera control unit 30a to optimize the exposure, the focus state, the hue, and the like in the gaze region on the basis of the gaze direction information. Even in a case where the site imaging system 3 does not include the direction indication device 32, performing such control is preferable in that the remote user 5 visually recognizes the same scene as the site user 6.

In the embodiment, an example has been described in which the control terminal 30 performs exposure control of the exposure of the omnidirectional camera 31 on the basis of the gaze direction information (see FIG. 15 and the like).

On the basis of the gaze direction information of the remote user 5, a corresponding region of the captured image in the omnidirectional camera 31 (region gazed by the remote user 5) is determined, and exposure control is performed so that the region is in an appropriate exposure state. As a result, the remote user 5 of the remote visual recognition system 1 can visually recognizes the properly exposed image. In particular, the image of the omnidirectional display device 11 has a region that is not visually recognized by the remote user 5, and the difference in luminance may be large depending on the size of the angle of view. By setting the region gazed by the remote user 5 to be in an appropriate exposure state, a high-quality image can be provided to the remote user 5 regardless of the width of the angle of view and the luminance difference. If the exposure in the gaze region is not appropriate, the remote user 5 has a reduced sense of immersion in the site. Therefore, this is also extremely suitable in that the remote user 5 visually recognizes the same scene as the site user 6 and views the same thing in the same manner. As a result, it can be expected to enhance sharing of a space, for example, a feeling of being together in a pseudo manner.

Furthermore, in the embodiment, an example has been described in which the control terminal 30 performs focus control and white balance control of the omnidirectional camera 31 on the basis of the gaze direction information.

On the basis of the gaze direction information of the remote user 5, a corresponding region of the captured image in the omnidirectional camera 31 (region gazed by the remote user 5) is determined, and focus control is performed so that the region is in an appropriate focus state. Alternatively, the white balance control is performed according to the region. As a result, the remote user 5 of the remote visual recognition system 1 can visually recognize the image as a focused image or an image with more faithful color reproduction.

In the second embodiment, an example has been described in which the remote visual recognition system 1 includes the eye tracking device 15 (line-of-sight detection device) that detects the line-of-sight direction of the viewer, and the control terminal 10 generates the gaze direction information using the detection result of the eye tracking device 15 (see FIGS. 16 and 17).

By generating the gaze direction information in consideration of the detection of the eye tracking device 15, the gaze direction of the remote user 5 can be more accurately determined. In particular, by correcting the gaze direction information (α, β) based on the detection by the head position/direction detection device 12 in the line-of-sight direction detected by the eye tracking device 15, the accuracy of the gaze direction is improved.

Furthermore, by transmitting the line-of-sight direction detected by the eye tracking device 15 in addition to the gaze direction information (α, β), the direction indication device 32 can perform head control and eyeball control of the avatar or the like, and the state of the remote user 5 can be more accurately conveyed to the site user 6.

Note that the detection result by the head position/direction detection device 12 is merely information on the position and direction of the head, and does not include the line-of-sight direction. However, in a case of using the omnidirectional display device 11 including a large screen that cannot be viewed entirely in the visual field of a person, the gaze region can be determined as a range that covers the difference in the line-of-sight direction. Therefore, it is not always necessary to use the eye tracking device 15. However, determining the accurate gaze region using the information on the eye tracking device 15 is meaningful in that the control of the omnidirectional camera 31 and the visibility improvement range are further optimized.

In the third embodiment, an example has been described in which the remote visual recognition system 1 includes the sub display 16 (sub display device) to which the viewer can perform operation input. Then, the control terminal 10 controls the display image of the sub display 16 on the basis of the information on the position and direction of the head of the viewer by the head position/direction detection device 12, and generates the gaze direction information according to the operation of designating the inside of the display image of the sub display 16 (see FIGS. 18 to 22).

By using the sub display 16, the remote user 5 can confirm an image of a region gazed in the omnidirectional display device 11 at hand. Then, a position in the image can be designated by a touch operation or the like. As a result, the gaze position of the remote user 5 can be determined more accurately, and appropriate gaze direction information can be generated.

In the fourth embodiment, the control terminal 10 of the remote visual recognition system 1 performs processing of generating the affection data of the viewer and transmitting the affection data to the site imaging system 3.

In addition, the control terminal 30 of the site imaging system 3 performs processing of causing the direction indication device 32 to execute the affection presentation on the basis of the affection data from the remote visual recognition system 1 (see FIGS. 23 and 24).

As a result, the site user 6 can know the feeling, gesture, and the like of the remote user 5 who shares the site space in a pseudo manner. Accordingly, smooth communication can be promoted.

In the fifth embodiment, an example has been described in which the control terminal 10 of the remote visual recognition system 1 performs the rotation control of the image displayed on the omnidirectional display device 11 according to the rotation operation of the viewer, and reflects the operation amount and the rotation direction of the rotation operation in the gaze direction information (see FIGS. 25 to 27).

The remote user 5 can rotate the image of the omnidirectional display device 11 by operation, and can obtain a state more easily viewable for the convenience of the remote user 5. In this case, by reflecting the amount and direction of the rotation operation also in the gaze direction information, the gaze direction information to be transmitted to the site imaging system 3 can be correct information as the direction from the omnidirectional camera 31.

In the sixth embodiment, an example has been described in which the control terminal 30 of the site imaging system 3 controls the compression rate of the captured image to be transmitted to the remote visual recognition system 1 for each image region on the basis of the gaze direction information of the viewer of the omnidirectional display device 11 in the remote visual recognition system 1 (see FIGS. 28 and 29).

As a result, while a high-definition image is displayed for a region gazed by the remote user 5, a region not viewed by the remote user 5 is transmitted as an image with a high compression rate, so that the amount of transmission data can be reduced without deteriorating the quality of the experience of the remote user 5, and the communication band can be saved.

The direction indication device 32 according to the embodiment expresses the head by an entity or an image, and indicates the direction by the orientation of the head (see FIGS. 3 to 10).

The direction indication device 32 expresses the head of a human, an animal, an imaginary creature, a two-dimensional character, a robot, or the like, and expresses the direction in which the remote user 5 is gazing by the orientation of the head. As a result, the site user 6 can grasp the direction in which the remote user 5 is gazing, similarly to the case of being on the site together.

Although the embodiments have been mainly described by taking the case of remote travel as an example, the technology of the embodiments is useful not only for remote travel but also for various cases. For example, in a case where the site is an event venue, a theme park, or the like, and further, in a sports venue, a music live venue, a theater, a camp site, a museum, a museum, or the like, the experience can be shared between the site and a remote location. Furthermore, the site may be a place where the omnidirectional camera 31 or the like as a fixed point camera is installed.

In addition, the techniques described in the first to sixth embodiments can be applied in any combination.

The program of the embodiment is a program for causing a processor such as a CPU or a DSP, or a device including the CPU or the DSP to execute the processing of the control terminal 10 as illustrated in FIGS. 14, 17, 21, and 22 or the processing of the control terminal 30 as illustrated in FIGS. 15, 24, and 29.

That is, the program of the embodiment is a program for causing a control device to execute processing of displaying a captured image at a remote location transmitted from the site imaging system 3 on the display device (omnidirectional display device 11) that displays an image having a wider angle than a visual field range of a person, and processing of generating gaze direction information on the basis of information on the position and direction of the head of the viewer by the head position/direction detection device 12 and transmitting the gaze direction information to the site imaging system 3.

In addition, the program of the embodiment is a program for causing the control device to execute processing of transmitting a captured image of the imaging device (omnidirectional camera 31) that captures an image wider than a visual field range of a person to the remote visual recognition system 1, and processing of controlling an instruction direction by the direction indication device 32 on the basis of gaze direction information of the viewer of the display device in the remote visual recognition system 1.

In addition, the program of the embodiment is a program for causing the control device to execute processing of transmitting a captured image of the imaging device (omnidirectional camera 31) that captures an image wider than a visual field range of a person to the remote visual recognition system 1, and control of the imaging device based on gaze direction information of the viewer of the display device in the remote visual recognition system 1.

By the program as described above, the information processing apparatus 70 that can be used as the control terminals 10 and 30 in the remote visual recognition system 1 and the site imaging system 3 described above can be realized by various computer apparatuses.

Such a program can be recorded in advance in an HDD as a recording medium built in a device such as a computer apparatus, a ROM in a microcomputer having a CPU, or the like. Furthermore, such a program can be temporarily or permanently stored (recorded) in a removable recording medium such as a flexible disk, a compact disc read only memory (CD-ROM), a magneto optical (MO) disk, a digital versatile disc (DVD), a Blu-ray Disc (registered trademark), a magnetic disk, a semiconductor memory, or a memory card. Such a removable recording medium can be provided as so-called package software.

Furthermore, such a program may be installed from the removable recording medium into a personal computer and the like, or may be downloaded from a download site through a network such as a local area network (LAN) or the Internet.

Furthermore, such a program is suitable for providing the information processing apparatus 70 of the embodiments in a wide range. For example, by downloading the program to a personal computer, a communication device, a portable terminal device such as a smartphone or a tablet, a mobile phone, a game device, a video device, a personal digital assistant (PDA), or the like, these devices can be caused to function as the information processing apparatus 70 (control terminal 10, 30) of the present disclosure.

Note that, the effects described in the present specification are merely examples and are not limited, and other effects may be provided.

Note that the present technology can also have the following configurations.
(1)

A remote visual recognition system including:
display device that displays an image at a wider angle than a visual field range of a person;
a head position/direction detection device that detects a position and a direction of a head of a viewer of the display device; and
a control device that performs processing of causing the display device to display a captured image at a remote location transmitted from a site imaging system, and processing of generating gaze direction information on the basis of information on the position and the direction of the head of the viewer by the head position/direction detection device, and transmitting the gaze direction information to the site imaging system.
(2)

The remote visual recognition system according to (1), in which
the gaze direction information is information indicating a gaze direction of the viewer obtained by a position and a direction of the head in a direction based on a position of an imaging device of the site imaging system.
(3)

The remote visual recognition system according to (1) or (2), in which
the display device is an omnidirectional display device that allows one or a plurality of viewers to visually recognize a display image by arbitrarily moving a position.
(4)

The remote visual recognition system according to any one of (1) to (3), further including
a line-of-sight detection device that detects a line-of-sight direction of the viewer,
in which the control device generates the gaze direction information using a detection result of the line-of-sight detection device.
(5)

The remote visual recognition system according to any one of (1) to (4), further including
a sub display device to which the viewer can perform an operation input,
in which the control device controls a display image of the sub display device on the basis of information on a position and a direction of the head of the viewer by the head position/direction detection device, and generates the gaze direction information according to an operation of designating an inside of the display image of the sub display device.
(6)

The remote visual recognition system according to any one of (1) to (5), in which
the control device performs processing of generating affection data of the viewer and transmitting the affection data to the site imaging system.
(7)

The remote visual recognition system according to any one of (1) to (6), in which
the control device performs rotation control of an image displayed on the display device according to a rotation operation of the viewer, and
reflects an operation amount and a rotation direction of the rotation operation in the gaze direction information.
(8)

A site imaging system including:
an imaging device that captures an image at a wider angle than a visual field range of a person;
a direction indication device that indicates a direction; and
a control device that performs processing of transmitting a captured image of the imaging device to a remote visual recognition system and processing of controlling an indication direction by the direction indication device on the basis of gaze direction information of a viewer of a display device in the remote visual recognition system.
(9)

The site imaging system according to (8), in which
the control device performs exposure control of the imaging device on the basis of the gaze direction information.
(10)

The site imaging system according to (8) or (9), in which
the control device performs one of focus control and white balance control of the imaging device on the basis of the gaze direction information.
(11)

The site imaging system according to any one of (8) to (10), in which
the control device performs processing of causing the direction indication device to execute affection presentation on the basis of affection data regarding the viewer of the display device in the remote visual recognition system.
(12)

The site imaging system according to any one of (8) to (11), in which
the control device controls a compression rate of a captured image to be transmitted to the remote visual recognition system for each image region on the basis of gaze direction information of the viewer of the display device in the remote visual recognition system.
(13)

The site imaging system according to any one of (8) to (12), in which
the direction indication device expresses a head by an entity or an image, and indicates a direction by an orientation of the head.
(14)

A site imaging system including:
an imaging device that captures an image at a wider angle than a visual field range of a person; and
a control device that performs processing of transmitting a captured image of the imaging device to a remote visual recognition system, and controls the imaging device on the basis of gaze direction information of a viewer of a display device in the remote visual recognition system.
(15)

The site imaging system according to (14), in which
the control device performs exposure control of the imaging device on the basis of the gaze direction information.
(16)

The site imaging system according to (14) or (15), in which
the control device performs one of focus control and white balance control of the imaging device on the basis of the gaze direction information.

### REFERENCE SIGNS LIST

1 Remote visual recognition system
2 Network
3 Site imaging system
5 Remote user (viewer)
6 Site user
10 Control terminal
10a Display control unit
10b Gaze information processing unit
11 Omnidirectional display device
12 Head position/direction detection device
15 Eye tracking device
16 Sub display
19 Operation unit
30 Control terminal
30a Camera control unit
30b Direction indication control unit
31 Omnidirectional camera
32 Direction indication device

1. A remote visual recognition system comprising:
a display device that displays an image at a wider angle than a visual field range of a person;
a head position/direction detection device that detects a position and a direction of a head of a viewer of the display device; and
a control device that performs processing of causing the display device to display a captured image at a remote location transmitted from a site imaging system, and processing of generating gaze direction information on a basis of information on the position and the direction of the head of the viewer by the head position/direction detection device, and transmitting the gaze direction information to the site imaging system.

2. The remote visual recognition system according to claim 1, wherein
the gaze direction information is information indicating a gaze direction of the viewer obtained by a position and a direction of the head in a direction based on a position of an imaging device of the site imaging system.

3. The remote visual recognition system according to claim 1, wherein
the display device is an omnidirectional display device that allows one or a plurality of viewers to visually recognize a display image by arbitrarily moving a position.

4. The remote visual recognition system according to claim 1, further comprising
a line-of-sight detection device that detects a line-of-sight direction of the viewer,
wherein the control device generates the gaze direction information using a detection result of the line-of-sight detection device.

5. The remote visual recognition system according to claim 1, further comprising
a sub display device to which the viewer can perform an operation input,
wherein the control device controls a display image of the sub display device on a basis of information on a position and a direction of the head of the viewer by the head position/direction detection device, and generates the gaze direction information according to an operation of designating an inside of the display image of the sub display device.

6. The remote visual recognition system according to claim 1, wherein
the control device performs processing of generating affection data of the viewer and transmitting the affection data to the site imaging system.

7. The remote visual recognition system according to claim 1, wherein
the control device performs rotation control of an image displayed on the display device according to a rotation operation of the viewer, and
reflects an operation amount and a rotation direction of the rotation operation in the gaze direction information.

8. A site imaging system comprising:
an imaging device that captures an image at a wider angle than a visual field range of a person;
a direction indication device that indicates a direction; and
a control device that performs processing of transmitting a captured image of the imaging device to a remote visual recognition system and processing of controlling an indication direction by the direction indication device on a basis of gaze direction information of a viewer of a display device in the remote visual recognition system.

9. The site imaging system according to claim 8, wherein
the control device performs exposure control of the imaging device on a basis of the gaze direction information.

10. The site imaging system according to claim 8, wherein
the control device performs one of focus control and white balance control of the imaging device on a basis of the gaze direction information.

11. The site imaging system according to claim 8, wherein
the control device performs processing of causing the direction indication device to execute affection presentation on a basis of affection data regarding the viewer of the display device in the remote visual recognition system.

12. The site imaging system according to claim 8, wherein
the control device controls a compression rate of a captured image to be transmitted to the remote visual recognition system for each image region on a basis of gaze direction information of the viewer of the display device in the remote visual recognition system.

13. The site imaging system according to claim 8, wherein
the direction indication device expresses a head by an entity or an image, and indicates a direction by an orientation of the head.

14. A site imaging system comprising:
an imaging device that captures an image at a wider angle than a visual field range of a person; and
a control device that performs processing of transmitting a captured image of the imaging device to a remote visual recognition system, and controls the imaging device on a basis of gaze direction information of a viewer of a display device in the remote visual recognition system.

15. The site imaging system according to claim 14, wherein
the control device performs exposure control of the imaging device on a basis of the gaze direction information.

16. The site imaging system according to claim 14, wherein
the control device performs one of focus control and white balance control of the imaging device on a basis of the gaze direction information.
